(19) United States
(12) Patent Application Publication
(10) Pub. No.: US 2007/0014018 A1
(43) Pub. Date: Jan. 18, 2007

(54) Internal components of optical device comprising hardcoat

(76) Inventors: John A. Wheatley, Lake Elmo, MN (US); Christopher B. Walker JR., St. Paul, MN (US); Michelle M. Bellanca, Stillwater, MN (US); Sharon Wang, St. Paul, MN (US); Naiyong Jing, Woodbury, MN (US); Zai-Ming Qiu, Woodbury, MN (US); Thomas P. Klun, Lakeland, MN (US); Richard J. Pokorny, Maplewood, MN (US); George G.I. Moore, Afton, MN (US); Mark J. Pellerite, Woodbury, MN (US)

Correspondence Address: 3M INNOVATIVE PROPERTIES COMPANY, PO BOX 33427, ST. PAUL, MN, 55133-3427, US

(21) Appl. No.: 11/267,790

(22) Filed: Nov. 5, 2005

Related U.S. Application Data
(63) Continuation-in-part of application No. 11/026,700, filed on Dec. 30, 2004.

(51) Int. Cl. G02B 1/10

(52) U.S. Cl. 359/580

(57) ABSTRACT

Methods of protecting internal components of an optical device are described by providing a hardcoat surface layer on an internal component of an optical device. Also described are certain internal components having hardcoat surface layers, as well as methods of assembling internal components of an optical device.

### RELATED APPLICATIONS

This application claims priority to U.S. application Ser. No. 11/026,700, filed Dec. 30, 2004 and U.S. application Ser. No. 11/121,456, filed May 4, 2005.

### BACKGROUND

U.S. Pat. No. 6,132,861 (Kang et al.); U.S. Pat. No. 6,238,798 B1 (Kang et al.); U.S. Pat. No. 6,245,833 B1 (Kang et al.); U.S. Pat. No. 6,299,799 (Craig et al.), Published PCT Application No. WO 99/57185 (Huang et al.) as well as (Liu et al.), U.S. Pat. Nos. 6,660,388; 6,660,389; and 6,841,190 hardcoat compositions containing blends of colloidal inorganic oxide particles, a curable binder precursor and certain fluorochemical compounds.

### BRIEF DESCRIPTION OF THE DRAWINGS

FIG. 1 is schematic diagram of an exemplary method of assembly of an optical imaging device.

FIG. 2 is a cross-sectional view of an illustrative internal component of an optical device comprising a hardcoat surface layer.

FIG. 3 is a cross-sectional view of an illustrative internal component of an optical device comprising a protective film article with a hardcoat surface layer.

FIG. 4 is an exemplary article comprising a plurality of internal components bonded to a hardcoat protective film.

FIG. 5 is a cross-sectional view of an exemplary optical imaging device.

### SUMMARY

In one embodiment, an article comprising an internal component of an optical device is described. The article comprises an internal component comprises a hardcoat surface layer comprising the reaction product of a polymerizable composition comprising at least 0.2 wt-% of at least one fluorochemical component having at least one polymerizable moiety, and at least 50 wt-% of one or more optionally fluorinated crosslinking agents. The crosslinking agents are typically non-fluorinated. For embodiments that employ a crosslinker comprising a fluorinated moiety, the hardcoat composition may comprise up to 100 wt-% of the crosslinker.

In another embodiment, and article comprising an internal component of an optical device is described wherein the internal component comprises a hardcoat surface layer and the surface layer has a static contact angle with water of at least 70 degrees.

In one aspect, the article is a sheet of components of an optical device comprising a protective film comprising a cured hardcoat surface layer and a plurality of components of an optical device wherein the components have at least one discernible boundary and the components are bonded to the cured hardcoat surface layer.

In another aspect, the article is wavelength selective filter comprising an absorptive layer comprising the reaction product of at least 50 wt-% of one or more crosslinking agents having two or more polymerizable moieties, at least 0.5 wt-% of at least one fluorochemical component having at least one polymerizable moiety or inorganic particles, and an absorptive ingredient.

In other embodiments, methods of protecting internal components of an optical device are described. The method comprises providing the described hardcoat surface layer on an internal component of an optical device by means of various techniques.

In another embodiment, a method of assembling an optical device is described. The method comprises assembling internal components of an optical device wherein at least one internal component comprises the described hardcoat surface layer(s).

### DETAILED DESCRIPTION OF PREFERRED EMBODIMENTS

Various optical devices are known. Optical devices employ various components for the purpose of sensing, imaging, projection, and illumination with light.

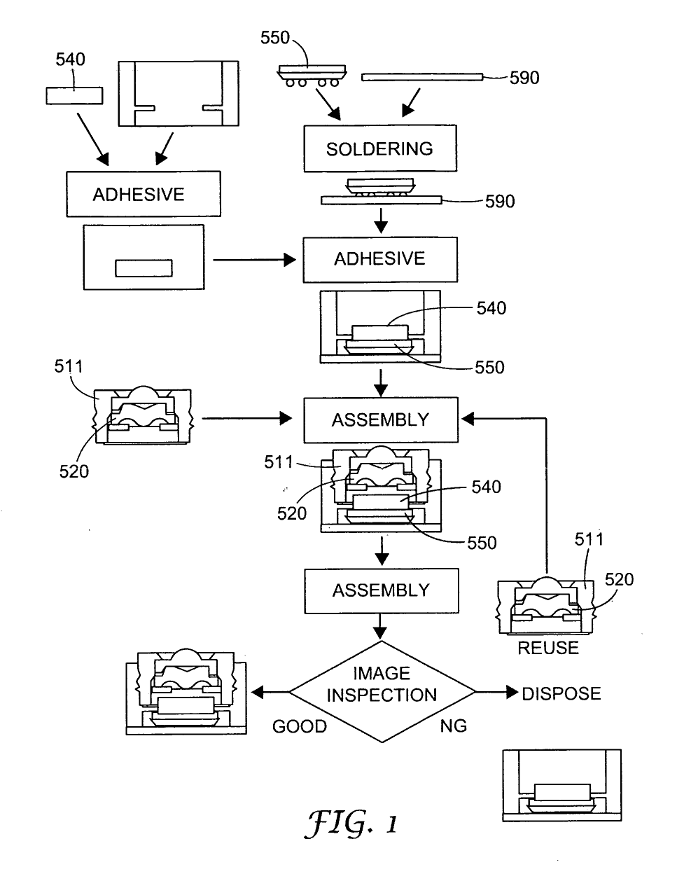

During the manufacture of an optical device, various individual components are assembled many of which are internal components, i.e. are unexposed to the external environment during normal usage of the optical device. Internal components of optical devices are susceptible to damage and exposure to debris during assembly of the optical device. One exemplary method of assembly is depicted in FIG. 1. The method comprises attaching an image sensor 550 to the (e.g. flexible) printed circuit board 590, typically by means of soldering. The infared (IR) filter 540 is then (e.g. adhesively) bonded to the image sensor 550. A lens(es) 520, pre-assembled in a cylindrical housing 511, is then (e.g. adhesively) bonded to the IR filter. Various suppliers, such as Asia Optical, Flextronic, Lite-on Tech, SEMCO, Hicel, Samsung Techwin, Pixart, IC Media, West Electric, Sanshin, Panasonic and Sharp produce the preassembled camera module having the iris, lens(es), filter, cover glass. The preassembled camera modules can be attached to the image sensor as part of an assembly process. Handset manufactures such as Nokia, Motorola, Samsung, LG, SonyEriccson, Siemens, Panasonic, and Sanyo then assemble the camera modules into the final camera.

Each internal component of the (e.g. camera) optical device has a defect threshold dependent on the function of the component and the design of the device. For example, factors such as distance of the component from the focal plane and resolution of the imager factor into the defect threshold of a digital camera. If any one of the individual components contains debris or is damaged during the assembly, such defect can cause the entire camera to be defective. In many instances, it is not possible to detect a defective component until the entire device has been assembled and tested. It is not uncommon in the assembly process for the number of defective devices to range as high as 10-20% at a loss to the manufacturer of tens to hundreds of dollars per unit or more. Oftentimes cleaning and re-working contaminated or damaged components is not practical or is prohibitively expensive.

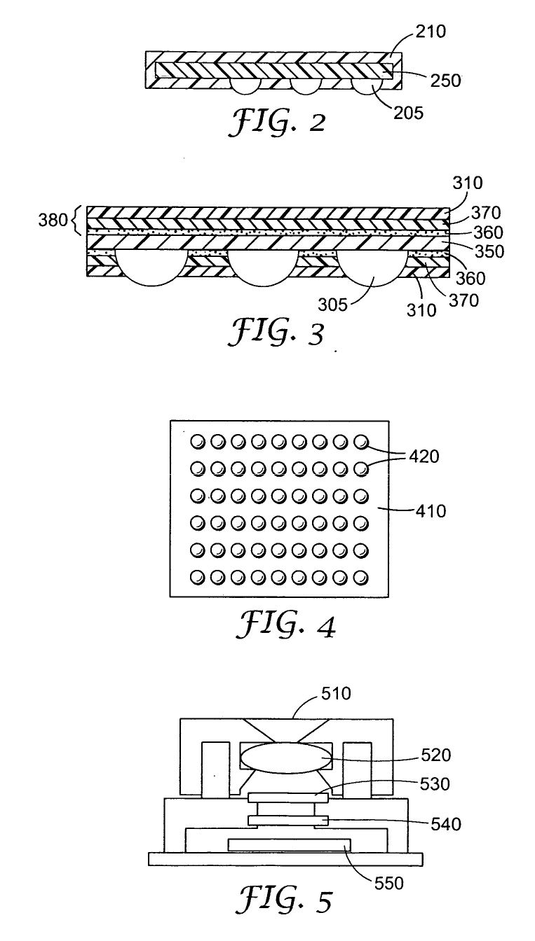

Accordingly, it would be advantageous to reduce the occurrence of defective parts prior to and during the assembly process as well as facilitate the cleaning, repair, and rework of optical components. As a solution to this problem, presently described are methods of protecting an internal component of an optical device by providing a hardcoat surface layer on an internal component. Also described are internal components having hardcoat surface layers, as well as methods of assembling internal components of an optical device. The hardcoat is a tough, abrasion resistant layer that protects the internal component from contaminants (e.g. solvents) scratches, and abrasion. The internal component (e.g. image sensor) 250 comprises hardcoat composition 210 disposed on the surface(s) of the internal component, as depicted in FIG. 2. The electrical contacts 205 (e.g. solder bumbs) of the image sensor protrude through the hardcoat surface layer so the image sensor can make electrical contact with the printed circuit board during assembly. The hardcoat comprises a polymerizable binder precursor, optionally in combination with inorganic particles. The hardcoat composition is preferably an easy-clean hardcoat.

The hardcoat surface layer is preferably durable, meaning that the surface exhibits substantially no surface damage or significant loss of optical properties (e.g. retains 97% of its original transmission) after durability testing conducted according to the test method described in the examples wherein steelwool is employed with a 200 g weight and at least 50, more preferably at least 100 and more preferably at least 500 wipes. Further, the surface layer and articles preferably continues to exhibit the previously described low surface energy properties (e.g. high contact angles, ink repellency, and bead up) even after such durability testing.

When it is desired that the hardcoat layer is also easy to clean, it is preferred that the hardcoat surface layer comprises one or more fluorinated components. The fluorinated component generally includes monomers, oligomers, and polymers comprising one or more (per)fluorinated moieties. The fluorinated component preferably further comprises one or more moieties that copolymerize with the binder precursor composition of the hardcoat. Hardcoats having such copolymerizable fluorinated components are referred to herein as “easy-clean hardcoats.”

The surface energy of the easy-clean hardcoat surface layer can be characterized by various methods such as contact angle and ink repellency, as determined according to the test methods described in the examples. The surface layer preferably exhibits a static contact angle with water of at least 70°. More preferably the contact angle with water is at least 80° and even more preferably at least 90° (e.g. at least 95°, at least 100°). Alternatively or in addition thereto, the advancing contact angle with hexadecane is at least 50° and more preferably at least 60°. Low surface energy is indicative of anti-soiling properties as well as the surface being easy to clean. As yet another indication of low surface energy, ink from a marker commercially available under the trade designation “Sanford Sharpie, Fine Point permanent marker, no 30001” preferably beads up. Further, the surface layer and articles described herein exhibit “ink repellency”, meaning that the ink can easily be removed by wiping with a tissue commercially available from Kimberly Clark Corporation, Roswell, Ga. under the trade designation “SURPASS FACIAL TISSUE”.

In view of their high contact angles with water, easy-clean hardcoat surface layers can also protect internal components of optical device by providing a moisture barrier.

In some embodiments, the hardcoat is provided as a single layer such as depicted in FIG. 2. In other embodiments, the hardcoat may comprise a multi-layer construction. For example a surface layer comprising an easy-clean hardcoat may be prepared by sequential coating, drying, and curing of a (e.g. non-fluorinated) hardcoat layer, followed by coating, drying, and curing of a fluorinated surface layer, such as described in U.S. application Ser. No. 10/841,159, filed May 7, 2004; or by coating, drying and curing of an easy-clean hardcoat in which the copolymerizable fluorinated components are formulated directly into the hardcoat, such as described in U.S. application Ser. No. 11/121,456, filed May 4, 2005. Without being bound by theory, in either case, the fluorinated components are present at the surface of the coating providing the easy-to-clean character. It is surmised that multi-layer easy-clean constructions can be prepared by simultaneous coating of a surface layer on top of a hardcoat layer, followed by drying and curing of both layers.

The total thickness of the hardcoat layer is typically about 1 to about 100 micrometers, about 2 to about 50 micrometers, or about 3 to about 30 micrometers. When an easy-clean fluorinated surface layer is applied to a (e.g. non-fluorinated hardcoat), the thickness of the easy-clean layer is at least about 10 nanometers, and preferably at least about 25 nanometers. Typically, the cured layer has a thickness of less than about 200 nanometers, preferably less than about 100 nanometers, and more preferably less than about 75 nanometers. Accordingly, the bulk of the durability is provided by the underlying (e.g. non-fluorinated) hardcoat layer.

Various methods may be employed to provide the hardcoat on the internal component.

In one aspect, the hardcoat is formed by coating a polymerizable liquid (e.g. ceramer) hardcoat composition onto the internal component and curing the polymerizable hardcoat composition to form a hardened film. The coating composition can be applied to the internal component using a variety of conventional coating methods. Suitable coating methods include, for example, spin coating, knife coating, die coating, wire coating, flood coating, padding, spraying, roll coating, dipping, brushing, foam application, printing and the like. The coating is dried, typically using a forced air oven. The dried coating is at least partially and typically completely cured using an energy source. After coating, the solvent, if any, is flashed off with heat, vacuum, and/or the like. The coated hardcoat composition is then cured by irradiation with a suitable form of energy, such as heat energy, visible light, ultraviolet light or electron beam radiation. Irradiating with ultraviolet light in ambient conditions is often utilized due to the relative low cost and high speed of this curing technique. Preferred energy sources include ultraviolet light curing devices that provide a UV “C” dosage of about 5 to 60 millijoules per square centimeter (mJ/cm²). Preferably curing takes place in an environment containing low amounts of oxygen, e.g., less than about 100 parts per million. Nitrogen gas is a preferred environment.

In other embodiments, a protective film comprising a cured hardcoat layer may be attached to the internal component by suitable means including for example heat lamination, thermoforming, adhesive bonding, or by means of ultrasonic or radio frequency bonding techniques. An adhesive may be applied to the internal component or pre-applied to the protective film. The protective film may simply include the cured hardcoat layer provided on a removable release liner or the protective film may further include additional layers such as a light transmissive substrate and/or an adhesive layer. For example, FIG. 3 depicts a protective film article 380 bonded to internal component (e.g. image sensor) 350. The protective film article comprises a crosslinked hardcoat surface layer 310 and a transparent substrate 370 disposed between the hardcoat surface layer and the internal component. An adhesive layer 360 bonds the protective film to the internal component 350. The lower surface of adhesive 360 may optionally be microstructured to allow air to escape when the adhesive layer contacts the internal component. The electrical contacts 205 (e.g. solder bumbs) of the image sensor protrude through the protective film so the image sensor can make electrical contact with the printed circuit board during assembly. Alternatively, the electrical contacts may be present on the opposing (e.g. top) surface. Masking or etching techniques can be employed to provided exposed electrical contacts.

One particularly advantageous use of the protective coating is to apply it to a substrate in an early part of the supply chain, where the material is applied to a mother-sheet, or pre-converted master of optical components. For example, the protective coating can be coated directly onto a large polymer “master sheet” (or alternatively a film with the coating on it can be laminated to the sheet) which is large enough that many individual components can be converted from it. Subsequently, the master sheet can be converted to individual parts by a variety of methods such as scoring, cutting, machining. A second example is similar application to wafer scale processing. Certain types of sensors such as silicon photodiodes are first prepared from cylindrical ingots into thin wafers of about 3-10 inches in diameter. These wafers are eventually diced (a process called singulation) into individual component size pieces that may further be packaged and incorporated into an optical component. Application of the protective coating at the wafer scale (pre-singulation) would have the advantage of incorporating the protective functionality to the individual pieces at the beginning of the supply chain, and therefore reducing damage of parts throughout the supply chain. The coating can be combined with additional optical elements such as filters to provide additional optical function as well.

The presently described hardcoat surface layer as well as the protective film (e.g. optionally further comprising a substrate and adhesive) does not detract from the optical qualities of the internal component.

The surface layer as well as the optional substrate and adhesive of the protective film article is light transmissive, meaning light can be transmitted through the substrate. The substrate of the protective film article does not substantially alter or impair the intended function of the internal optical component to which it is applied. The haze value of the surface layer as well as the optional substrate and adhesive substrate is preferably less than 5%, more preferably less than 2% and even more preferably less than 1%, and most preferably less than 0.5%. In addition thereto, the transmission is preferably greater than about 90%.

Various permanent and removable grade adhesive compositions may be provided on the opposite side of the substrate (i.e. to that of the hardcoat) so the article can be easily mounted to an internal component. Suitable adhesive compositions include (e.g. hydrogenated) block copolymers such as those commercially available from Kraton Polymers, Westhollow, Tex. under the trade designation “Kraton G-1657”, as well as other (e.g. similar) thermoplastic rubbers. Other exemplary adhesives include acrylic-based, urethane-based, silicone-based and epoxy-based adhesives. Preferred adhesives are of sufficient optical quality and light stability such that the adhesive does not yellow with time or upon weather exposure so as to degrade the viewing quality of the optical display. The adhesive can be applied using a variety of known coating techniques such as transfer coating, knife coating, spin coating, die coating and the like. Exemplary adhesives are described in U.S. Patent Application Publication No. 2003/0012936. Several of such adhesives are commercially available from 3M Company, St. Paul, Minn. under the trade designations 8141, 8142, and 8161.

In one embodiment, the protective film comprising the (e.g. easy-clean) hardcoat includes a UV curable adhesive. The UV curable adhesive is contacted to the internal component and irradiated with UV to couple the UV curable adhesive to the internal component. The release liner may be light transmissible such that the UV adhesive is cured through the release liner. Various UV adhesive compositions are known such as a UV curable coating commercially available from Mitsubishi Rayon under the trade designation “UR6530”.

In another embodiment, the protective film is thermally coupled to an internal component of an optical device by providing a mold having a bottom plate and a top plate; introducing the protective film such that said adhesive layer is closely coupled to the internal component; heating the top and bottom plate; closing the mold thereby adhering the adhesive layer to the optical substrate; opening the mold; and removing the optical device from the mold.

The protective film may be applied to individual internal components for example by (e.g. laser or die) cutting the protective film into small pieces (e.g. 5 mm by 5 mm) of appropriate size for the individual component(s) and employing a robotic pick and place handling system, as known in the art, to place and bond the protective film to the individual internal components. To facilitate handling the (e.g. easy-clean) protective film layer may be provided on a release liner wherein the hardcoat surface layer (e.g. together with the substrate and adhesive if present) is cut into portions of suitable size for placing on the internal components. The (i.e. uncut) release liner serves as a carrier web for the protective film layer pieces.

Alternatively, the protective film may be concurrently provided on a plurality (i.e. more than one) of internal components such as by spray or dip coating.

In one embodiment, the protective film can be applied to an internal component of an optical device via an in-mold transfer process. Such process may concurrently mold the internal component(s) and apply the protective film to the internal component. Such method may comprise introducing the protective film within an inner cavity of a molding die; closing the molding die; injecting a quantity of a molten polymeric material to substantially fill the inner cavity, cooling the molten polymeric material; removing the internal component having the protective film material applied from the molding die; and removing the release layer from the internal component. For example, a sheet of protective film may be inserted into a lens injection molding machine, prior to injection of the molten polymer employed to concurrently form multiple lenses. After injection molding, two or more individual lens 420 may be interconnected to each other by means of the hardcoat protective film 410, as depicted in FIG. 4. The lenses can subsequently be separated by severing the protective film by for example laser or die cutting.

This aspect facilitates manufacturing and handling by providing a sheet of a plurality of (e.g. internal) components of an optical device. The components have at least one discernible boundary and may be discreet components interconnected by only the hardcoat surface layer or the components may be contiguous. The components are typically non-planar such as the lens of FIG. 4. This sheet of components may also be formed by other methods such as bonding a plurality of components with any suitable bonding means, such as the bonding means described herein.

A variety of substrates can be utilized in the protective film article. Suitable substrate materials include glass (e.g. crown, flint, borosiliate) as well as thermosetting or thermoplastic polymers such as polycarbonate, poly(meth)acrylate (e.g., polymethyl methacrylate or “PMMA”), polyolefins (e.g., polypropylene or “PP”), polyurethane, polyesters (e.g., polyethylene terephthalate or “PET”), polyamides, polyimides, phenolic resins, cellulose diacetate, cellulose triacetate, polystyrene, styrene-acrylonitrile copolymers, epoxies, and the like. Typically the substrate will be chosen based in part on the desired optical and mechanical properties for the intended use. Such mechanical properties typically will include flexibility, dimensional stability and impact resistance. The substrate thickness typically also will depend on the intended use. For most applications, substrate thicknesses of less than about 0.5 mm are preferred, and more preferably about 0.02 to about 0.2 mm. Self-supporting polymeric films are preferred. Films made from polyesters such as PET or polyolefins such as PP (polypropylene), PE (polyethylene) and PVC (polyvinyl chloride) are particularly preferred. The polymeric material can be formed into a film using conventional filmmaking techniques such as by extrusion and optional uniaxial or biaxial orientation of the extruded film. The substrate can be treated to improve adhesion between the substrate and the hardcoat layer, e.g., chemical treatment, corona treatment such as air or nitrogen corona, plasma, flame, or actinic radiation. If desired, an optional tie layer or primer can be applied to the substrate and/or hardcoat layer to increase the interlayer adhesion.

Various internal components of optical devices can benefits from the inclusion of a hardcoat surface layer. In some embodiments the internal component may be a substantially planar film, such as in the case of optical films. In other embodiments, the internal component may be a small discrete part, having a maximum dimension ranging from about 5 cm to 20 cm. In some instance, the internal optical component may be a flexible film. However, in other embodiments, the internal component is rigid.

Although the internal component may consist of an inorganic material such as glass, the internal component typically comprises a polymeric material such as a thermoplastic, thermoset, or crosslinked polymerized resin.

In the case of an optical display for example, the internal component may be an optical film such as multilayer optical films, microstructured films such as brightness enhancing films, (e.g. reflective or absorbing) polarizing films, diffusive films, as well as (e.g. biaxial) retarder films and compensator films. The internal component may also comprise monolithic substrate film. The internal component may also comprise any of the materials previously described for use as the substrate of the protective film article.

The term “optical display”, or “display panel”, can refer to any conventional non-illuminated and in particular illuminated optical displays, including but not limited to multi-character multi-line displays such as liquid crystal displays (“LCDs”), plasma displays, front and rear projection displays, cathode ray tubes (“CRTs”), and signage, as well as single-character or binary displays such as light emitting diodes (“LEDs”), signal lamps and switches. The exposed surface of such display panels may be referred to as a “lens.”

As described is U.S. Patent Application 2003/0217806; incorporated herein by reference, multilayer optical films, i.e., films that provide desirable transmission and/or reflection properties at least partially by an arrangement of microlayers of differing refractive index. The microlayers have different refractive index characteristics so that some light is reflected at interfaces between adjacent microlayers. The microlayers are sufficiently thin so that light reflected at a plurality of the interfaces undergoes constructive or destructive interference in order to give the film body the desired reflective or transmissive properties. For optical films designed to reflect light at ultraviolet, visible, or near-infrared wavelengths, each microlayer generally has an optical thickness (i.e., a physical thickness multiplied by refractive index) of less than about 1 μm. However, thicker layers can also be included, such as skin layers at the outer surfaces of the film, or protective boundary layers disposed within the film that separate packets of microlayers. Multilayer optical film bodies can also comprise one or more thick adhesive layers to bond two or more sheets of multilayer optical film in a laminate.

The reflective and transmissive properties of multilayer optical film body are a function of the refractive indices of the respective microlayers. Each microlayer can be characterized at least at localized positions in the film by in-plane refractive indices nₓ, n_{y}, and a refractive index n_{z} associated with a thickness axis of the film. These indices represent the refractive index of the subject material for light polarized along mutually orthogonal x-, y-, and z-axes. In practice, the refractive indices are controlled by judicious materials selection and processing conditions. Films can be made by co-extrusion of typically tens or hundreds of layers of two alternating polymers A, B, followed by optionally passing the multilayer extrudate through one or more multiplication die, and then stretching or otherwise orienting the extrudate to form a final film. The resulting film is composed of typically tens or hundreds of individual microlayers whose thicknesses and refractive indices are tailored to provide one or more reflection bands in desired region(s) of the spectrum, such as in the visible or near infrared. In order to achieve high reflectivities with a reasonable number of layers, adjacent microlayers preferably exhibit a difference in refractive index (Δnₓ) for light polarized along the x-axis of at least 0.05. If the high reflectivity is desired for two orthogonal polarizations, then the adjacent microlayers also preferably exhibit a difference in refractive index (Δ n_{y}) for light polarized along the y-axis of at least 0.05. Otherwise, the refractive index difference can be less than 0.05 and preferably about 0 to produce a multilayer stack that reflects normally incident light of one polarization state and transmits normally incident light of an orthogonal polarization state. If desired, the refractive index difference (Δ n_{z}) between adjacent microlayers for light polarized along the z-axis can also be tailored to achieve desirable reflectivity properties for the p-polarization component of obliquely incident light.

Exemplary materials that can be used in the fabrication of polymeric multilayer optical film can be found in PCT Publication WO 99/36248 (Neavin et al.), incorporated herein by reference. Desirably, at least one of the materials is a polymer with a stress optical coefficient having a large absolute value. In other words, the polymer preferably develops a large birefringence (at least about 0.05, more preferably at least about 0.1 or even 0.2) when stretched. Depending on the application of the multilayer film, the birefringence can be developed between two orthogonal directions in the plane of the film, between one or more in-plane directions and the direction perpendicular to the film plane, or a combination of these. In special cases where isotropic refractive indices between unstretched polymer layers are widely separated, the preference for large birefringence in at least one of the polymers can be relaxed, although birefringence is still often desirable. Such special cases may arise in the selection of polymers for mirror films and for polarizer films formed using a biaxial process, which draws the film in two orthogonal in-plane directions. Further, the polymer desirably is capable of maintaining birefringence after stretching, so that the desired optical properties are imparted to the finished film. A second polymer can be chosen for other layers of the multilayer film so that in the finished film the refractive index of the second polymer, in at least one direction, differs significantly from the index of refraction of the first polymer in the same direction. For convenience, the films can be fabricated using only two distinct polymer materials, and interleaving those materials during the extrusion process to produce alternating layers A, B, A, B, etc. Interleaving only two distinct polymer materials is not required, however. Instead, each layer of a multilayer optical film can be composed of a unique material or blend not found elsewhere in the film. Preferably, polymers being coextruded have the same or similar melt temperatures.

Exemplary two-polymer combinations that provide both adequate refractive index differences and adequate inter-layer adhesion include: (1) for polarizing multilayer optical film made using a process with predominantly uniaxial stretching, PEN/coPEN, PET/coPET, PEN/sPS, PET/sPS, PEN/Eastar™, and PET/Eastar™, where “PEN” refers to polyethylene naphthalate, “coPEN” refers to a copolymer or blend based upon naphthalene dicarboxylic acid, “PET” refers to polyethylene terephthalate, “coPET” refers to a copolymer or blend based upon terephthalic acid, “sPS” refers to syndiotactic polystyrene and its derivatives, and Eastar™ is a polyester or copolyester (believed to comprise cyclohexanedimethylene diol units and terephthalate units) commercially available from Eastman Chemical Co.; (2) for polarizing multilayer optical film made by manipulating the process conditions of a biaxial stretching process, PEN/coPEN, PEN/PET, PEN/PBT, PEN/PETG and PEN/PETcoPBT, where “PBT” refers to polybutylene terephthalate, “PETG” refers to a copolymer of PET employing a second glycol (usually cyclohexanedimethanol), and “PETcoPBT” refers to a copolyester of terephthalic acid or an ester thereof with a mixture of ethylene glycol and 1,4-butanediol; (3) for mirror films (including colored mirror films), PEN/PMMA, coPEN/PMMA, PET/PMMA, PEN/Ecdel™, PET/Ecdel™, PEN/sPS, PET/sPS, PEN/coPET, PEN/PETG, and PEN/THV™, where “PMMA” refers to polymethyl methacrylate, Ecdel™ is a thermoplastic polyester or copolyester (believed to comprise cyclohexanedicarboxylate units, polytetramethylene ether glycol units, and cyclohexanedimethanol units) commercially available from Eastman Chemical Co., and THV™ is a fluoropolymer commercially available from 3M Company.

Further details of suitable multilayer optical films and related constructions can be found in U.S. Pat. No. 5,882,774 (Jonza et al.), and PCT Publications WO 95/17303 (Ouderkirk et al.) and WO 99/39224 (Ouderkirk et al.), all of which are incorporated herein by reference. Polymeric multilayer optical films and film bodies can comprise additional layers and coatings selected for their optical, mechanical, and/or chemical properties. See U.S. Pat. No. 6,368,699 (Gilbert et al.). The polymeric films and film bodies can also comprise inorganic layers, such as metal or metal oxide coatings or layers.

In the case of optical imaging device, a hardcoat surface layer may be applied to any one or any combination of the internal components of such device. For example, with reference to FIG. 5, digital cameras generally comprise an exposed cover plate 510, internal lens(es) 520, an optional internal low pass filter 530, an internal infrared (IR) filter 540, and internal image sensor 550 (i.e. imager). The digital camera assembly may further include a cover glass (not shown) positioned between the image sensor and the IR filter. Cylindrical lens barrels are typically used to house these elements and hold them in relative position to one another based on the optical design of each specific camera. Additionally, a subassembly may be employed where some of the components are pre-assembled and then brought together in a final step.

Since the image sensor is generally the most expensive component of a digital camera, it is surmised to be particularly advantageous to provide a hardcoat surface layer on an image sensor, as previously depicted in FIGS. 2 and 3. The image sensor employed by most digital cameras as well as other optical imaging devices is typically either a charge coupled device (CCD) or a complementary metal oxide semiconductor (CMOS). Both CCD and CMOS image sensors convert light into electrons, which are then processed by component circuitry. Once the sensor converts the light into electrons, it detects the value (accumulated charge) of each cell in the image. The manner in which these sensor convert light is different. A CCD transports the charge across the chip and reads it at one corner of the array. An analog-to-digital converter then turns each pixel's value into a digital value by measuring the amount of charge at each photosite and converting that measurement to binary form. CMOS devices use several transistors at each pixel to amplify and move the charge using more traditional wires. The CMOS signal is digital, so it needs no analog to digital converter. Various image sensors are commercially available from including for example Primax, Toshiba, Agilent, Micron, Omnivision, ST Micro, Hynix, and Sony.

The image sensor can be encased in a package or provided as a bare chip. The image sensor may optionally be laminated between two sheets of glass and encapsulated in epoxy. The electrical contacts are routed to the back of the silicon, leaving the front, optically sensitive, side of the silicon exposed for light sensing. This type of image sensor is commercially available from Shellcase under the trade designation “ShellOP”. For this embodiment, the hardcoat surface layer may be provided on the image sensor prior to lamination or provided on the glass. Preferably, however, the (e.g. easy-clean) hardcoat or protective film is employed in place of the glass and epoxy as depicted in FIGS. 2 and 3.

In another embodiment, a hardcoat surface layer is provided on internal lens(es) used to focus the image to the detector. For cell phone cameras, such lens(es) are generally made of polycarbonate or polymethymethacrylate (i.e. acrylic). However for larger optical units lenses can be made of various types of glass such as borosilicate. Multiple lenses may be included in a single camera module. For embodiments that employ more than one lens, the lenses are often pre-assembled into a sub-assembly, such sub-assembly being provided to the final camera module assembler. Various lens and lens assembly are know and commercially available form various suppliers including from example Leica, Sharp, Konica, Enplas, Largan, Ricoh, Sekonix, and Canon.

In another embodiment, an easy-clean hardcoat surface layer, i.e. comprising a fluorinated component that copolymerizes with the binder of the hardcoat may be employed to provide an infared filter. Infrared (IR) cut-off filters are used with color CCD or CMOS imagers to produce true color images. An IR cut-off filter blocks the transmission of the infrared while passing the visible. Generally IR filters for electronic cameras block a range of wavelengths from about 650 nm to about 1100 nm so as to allow visible light to transmit to the sensor, but block near infrared light in the range of sensitivity of the detector. This can be done with two optical techniques: absorption or reflection. Absorptive filters are made with special optical glass that absorbs near infrared radiation. Reflection type filters are essentially short-pass interference filters that reflect infrared light with high efficiency. These can be made of multi-layer film comprising alternating layers of high and low refractive indices. IR filters are available from 3M under the trade designation “DFA”. Other suppliers of IR filters include Hoya, Ashai Techno Glass, Keihin Komaku, Matsunami Glass, Isuzu Glass, Sunex, and Lifetime.

U.S. Patent Application Publication No. US 2005/00411292, published Feb. 24, 2005; incorporated herein by reference, describes an optical film including a reflective interference element (e.g. as provided by a multilayer optical film) in combination with an absorptive element (e.g. as provided by one or more colorants, which can include pigments or dyes that absorb non-uniformly over visible wavelength), as described in U.S. Publication No. 2005/0041292; incorporated herein by reference. The pigment is dispersed in a matrix that forms a film. As an alternative to a multi-layer film, the interference element can alternatively comprise a cholesteric (chiral nematic) liquid crystal film, as known in the art. Alternatively, interference element can comprise a polymeric backing with a metal/inorganic oxide stack such as is described in U.S. Pat. No. 4,799,745 (Meyer et al.) or an alternating polymer/inorganic oxide stack prepared by the methods described in U.S. Pat. No. 5,440,446 (Shaw et al.), U.S. Pat. No. 5,725,909 (Shaw et al.), U.S. Pat. No. 6,010,751 (Shaw et al.), and U.S. Pat. No. 6,045,864 (Lyons et al.).

In one embodiment, an absorptive IR filter or an absorptive element of a reflective IR filter may be provided by adding an absorptive dye or absorptive colorant (i.e. absorbs in the visible light spectrum) to the easy-clean hardcoat compositions described herein. The cured hardcoat layer function as an IR filter. The absorptive easy-clean hardcoat composition can be coated onto a substrate or release liner to form an absorptive protective film, or the absorptive element can be coated directly on the interference element (e.g. multi-layer film), on an internal surface of the detector in the active area, or onto a window or lens element that covers the active area.

The interference element substantially reflects normally incident light in a spectral band lying primarily in the near-infrared region and to substantially transmit normally incident light over most or substantially all of the visible wavelength region. The interference element preferably provides an average transmission of at least about 50%, and more preferably at least about 70% in the visible region, and provides a transmission of less than about 5%, more preferably less than about 2% or 1% throughout a reflection band that extends into the near infrared region. For detector systems utilizing silicon photodiodes, the 5%, 2%, and 1% transmission limits preferably cover a range from about 800 nm to about 1100 nm, or from about 700 nm to about 1200 nm. In many cases the interference element has negligible absorption so that the percent transmission plus the percent reflection at a given wavelength is about 100%.

For photosensors wherein a human eye (photopic) response is desired, a green pigment, a yellow pigment, or preferably a combination thereof are dispersed in the easy-clean absorptive hardcoat composition. Preferred green pigments include phthalocyanine green and phthalocyanine green 6Y; whereas preferred yellow pigments include PY-150, PY-138, PY-139, PY-185, PY-180, and PY-110.

Infared absorbing dyes and pigments for use in the absorbing filter are known. (See for example U.S. Pat. No. 6,049,419). Suitable dye include for example phthalocyanine dyes, such as commercially available from Zeneca Corporation, under the trade designation “Project Series” for example, “Project 830NP”, “Project 860 NP” and “Project 900NP”. Suitable infrared absorbing pigments include cyanines, metal oxides and squaraines. Suitable pigments include those described in U.S. Pat. No. 5,215,838, incorporated herein by reference, such as metal phthalocyanines, for example, vanadyl phthalocyanine, chloroindium phthalocyanine, titanyl phthalocyanine, chloroaluminum phthalocyanine, copper phthalocyanine, magnesium phthalocyanine, and the like; squaraines, such as hydroxy squaraine, and the like; as well as mixtures thereof. Exemplary copper pthalocyanine pigments include the pigment commercially available from BASF under the trade designation “6912”. Other exemplary infrared pigments include the metal oxide pigment commercially available from Heubach Langelsheim under the trade designation “Heucodor”.

The amount of dye or pigment used in the optical body varies depending on the type of dye or pigment and/or the end use application. Typically, when applied to the surface of the film, the dye or pigment is present on the surface at a concentration and coating thickness suitable to accomplish the desired infrared absorption and visible appearance. Typically, if the dye or pigment is within an additional layer or within the multilayer optical body, the concentration ranges from about 0.05 to about 0.5 weight %, based on the total weight of the optical body. In addition, when a pigment is used, a small particle size typically is needed, for example, less than the wavelength of light.

The internal components of various other optical devices can benefit by providing a hardcoat or easy-clean hardcoat surface layer, as described herein. For example, the hardcoat may be provided on a photosensor. A photosensor is an electronic component that detects the presence of visible light, infared (IR) transmission, and/or ultraviolet (UV) energy. Most photosensors consist of semiconductor having a property called photoconductivity, in which the electrical conductance varies depending on the intensity of radiation striking the material. The most common types of photosensor are the photodiode, the bipolar phototransistor, and the photoFET (photosensitive field-effect transistor). These devices are essentially the same as the ordinary diode, bipolar transistor, and field-effect transistor, except that the packages have transparent windows that allow radiant energy to reach the junctions between the semiconductor materials inside. Bipolar and field-effect phototransistors provide amplification in addition to their sensing capabilities. Silicon photodiodes are an example of sensors that are used in non-imaging photodection systems where visible or near infrared light is converted into an electrical signal for detecting the intensity of light for example in a brightness sensor. Photosensors are used in a great variety of electronic devices, circuits, and systems, including: fiber optic systems, optical scanners, wireless LAN, automatic lighting controls, machine vision systems, electric eyes, optical disk drives, optical memory chips, and remote control devices.

Internal components of various optical imaging, sensing, projection and illumination systems, can benefit from a (e.g. easy-clean) hardcoat surface layers described herein.

Imaging systems include cameras, telescopes, binoculars, microscopes, and medical imaging systems. Projection systems include Liquid Crystal on Silicon (LCOS), Digital Light Processing (DLP), and High Temperature Poly-Silicon (HTPS). Displays include CRT, Plasma, Organic Light emitting diode (OLED), liquid crystal display (LCD), and field emissive displays. Sensing systems include bar code scanners, CD-DVD, guidance systems, and remote control systems. Energy and Light management systems include light pipes, luminaries, and solar concentrators. Illumination sources include Light Emitting Diodes, fluorescent, arc, incandescent, halogen, OLED, and electroluminescent.

The internal optical component may include for example color filter wheels (such as those used in Digital Light Projection (DLP) systems); polarizing beam splitter cubes (e.g., those used in digital projection systems employing the Liquid Crystal on Silicon (LCOS) technology for color separation/re-combination), and various other types of prisms used for splitting and redirecting light (e.g. a TIR prism is used for changing the direction of the light path in digital projection systems); mirrors (such as silver front coated mirrors used in digital projection to redirect or bend light to desired areas). Also, polarizers are common optical components in for example LCOS systems, and these include absorptive, wire grid, and birefringent polarizers. Additional optical components include windows, gratings, diffusers, retarders, liquid crystal panels, lightguides, and structured surface films having prisms or lenslet arrays. Prisms, beamsplitters, filters, and various mirrors are available from companies such as Schott Glass and Bausch & Lomb. Silicon photodiodes can be obtained from Hamamatsu Corporation. Polarizers are available from several companies including Sumitomo Chemical, and 3M Company. Prism films, such as brightness enhancing film, are also available from 3M Company.

The internal component(s) having the (e.g. easy-clean) hardcoat layer can be assembled into an optical device with any one of various known methods of assembly such as the illustrative assembly method depicted in FIG. 1. Due to the surface protection provided by the hardcoat, it is surmised that the method provides a higher yield of undefective imaging devices than the same method of assembling wherein the one or more internal component(s) lack the cured hardcoat surface layer.

The hardcoat comprises a polymerizable binder precursor, optionally, yet preferably in combination with inorganic particles. The easy-clean hardcoat further comprises at least one fluorinated component that copolymerizes with the binder,

A variety of binders can be employed in the hardcoat. The binder precursor as well as the optional fluorinated component comprises at least one polymerizable moiety, i.e., having a terminal moiety or moiety pendant from a monomer, oligomer, or polymer backbone that participates in crosslinking reactions upon exposure to a suitable source. As used herein, the term “monomer” refers to a single, one unit molecule capable of combination with itself or other monomers to form oligomers or polymers. The term “oligomer” refers to a compound that is a combination of 2 to 20 monomers. The term “polymer” refers to a compound that is a combination of 21 or more monomers. Suitable sources of curing energy include electron beam, heat (thermal energy), ultraviolet light, visible light, microwaves, infrared energy, and the like.

The binder is preferably derived from a free-radically polymerizable binder precursor that can be photocured once the hardcoat composition has been coated upon the internal component, release liner or substrate of the protective film. Representative examples of free-radically curable moieties include (meth)acrylate groups, olefinic carbon-carbon double bonds, allyloxy groups, alpha-methyl styrene groups, (meth)acrylamide groups, vinyl and vinyl ether groups, combinations of these, and the like.

Alternatively, however, polymerizable moieties such as epoxides and vinyl ethers can be cationically polymerized. A third kind of polymerizable group is polymerized by condensation polymerization and is driven to completion most often by heat. For example the material may comprise a silane groups (especially alkoxy silane groups) that condense with the surface groups, such as as silanols, on the surface of silica, silsesquioxanes, and siloxanes type coatings. Condensation of alkoxysilane groups is an example of sol-gel type chemistry. The binder precursor, optional fluorinated component, and optional inorganic particles may include multiple types of polymerizable groups that employ one or more cure mechanisms. Preferably, the polymerizable group of the fluorinated component is substantially the same as the polymerizable group of the binder. For example, both the binder and the fluorinated component may comprise (meth)acrylate polymerizable moieties or both the binder and the fluorinated component may comprise (e.g. hydrolyzable) silane moieties. Acrylate moieties tend to be preferred.

Various known hardcoat compositions can be employed including those described in U.S. Pat. No. 6,132,861 (Kang et al. '861), U.S. Pat. No. 6,238,798 B1 (Kang et al. '798), U.S. Pat. No. 6,245,833 B1 (Kang et al. '833) and U.S. Pat. No. 6,299,799 (Craig et al. '799); WO 99/57185 (Huang et al.); U.S. Pat. No. 5,677,050 (Bilkadi); U.S. Pat. No. 4,885,332 (Bilkadi), and U.S. Pat. No. 5,104,929 (Bilkadi); U.S. Pat. Nos. 6,660,388; 6,660,389; and 6,841,190 (Liu et al.), U.S. patent application Ser. No. 11/026,573, filed Dec. 30, 2004; U.S. application Ser. No. 11/009,181, filed Dec. 10, 2004; U.S. patent application Ser. No. 11/121,742, filed May 4, 2005; U.S. patent application Ser. No. 11/087,413, filed Mar. 23, 2005; and U.S. patent application Ser. No. 11/121,456, filed May 4, 2005, each incorporated herein by reference.

Various amounts of mono-, di-, tri-, tetra-, penta-, and hexafunctional free-radically curable monomers may be incorporated into the (e.g. free-radically) polymerizable binder precursor, depending upon the desired properties of the final ceramer composition or composite.

A variety of binders can be employed in the hardcoat. The binder can be derived from a free-radically polymerizable precursor that can be photocured once the hardcoat composition has been coated upon the substrate. Binder precursors such as the protic group-substituted esters or amides of an acrylic acid described in '799, or the ethylenically-unsaturated monomers described in '799 et al., are often preferred. Suitable binder precursors include polyacrylic acid or polymethacrylic acid esters of polyhydric alcohols, such as diacrylate or di(meth)acrylate esters of diols including ethyleneglycol, triethyleneglycol, 2,2-dimethyl-1,3-propanediol, 1,3-cyclopentanediol, 1-ethoxy-2,3-propanediol, 2-methyl-2,4-pentanediol, 1,4-cyclohexanediol, 1,6-hexamethylenediol, 1,2-cyclohexanediol, 1,6-cyclohexanedimethanol, resorcinol, pyrocatechol, bisphenol A, and bis(2-hydroxyethyl)phthalate; triacrylic acid or trimethacrylic acid esters of triols including glycerin, 1,2,3-propanetrimethanol, 1,2,4-butanetriol, 1,2,5-pentanetriol, 1,3,6-hexanetriol, 1,5,10-decanetriol, pyrogallol, phloroglucinol, and 2-phenyl-2,2-methylolethanol; tetraacrylic acid or tetramethacrylic acid esters of tetraols including 1,2,3,4-butanetetrol, 1,1,2,2-tetramethylolethane, 1,1,3,3-tetramethylolpropane, and pentaerythritol tetraacrylate; pentaacrylic acid or pentamethacrylic acid esters of pentols including adonitol; hexaacrylic acid or hexamethacrylic acid esters of hexanols including sorbitol, dipentaerythritol, dihydroxy ethyl hydantoin; and mixtures thereof. The binder can also be derived from one or more monofunctional monomers as described in Kang et al. '798. The binder comprises one or more N,N-disubstituted acrylamide and or N-substituted-N-vinyl-amide monomers as described in Bilkadi et al. The hardcoat may be derived from a ceramer composition containing about 20 to about 80% ethylenically unsaturated monomers and about 5 to about 40% N,N-disubstituted acrylamide monomer or N-substituted-N-vinyl-amide monomer, based on the total weight of the solids in the ceramer composition.

The binder of the hardcoat preferably derived from at least one multifunctional (e.g. free radically) polymerizable monomer, also referred to herein as crosslinker. Although fluorinated crosslinkers may also be employed, it is typically preferred to employ non-fluorinated crosslinkers alone or in combination with a fluorinated crosslinkers. Although as little as 5 wt-% crosslinker may result in suitable durability for some applications, it is typically preferred to maximize the concentration of crosslinker. Accordingly, the coating compositions described herein typically comprise at least 20 wt-% crosslinking agent(s). The total amount of crosslinking agent(s) may comprise at least 50 wt-% and may be for example at least 60 wt-%, at least 70 wt-%, at least 80 wt-%, at least 90 wt-% and even about 95 wt-% of the polymerizable coating composition.

Useful free radically polymerizable crosslinking agents include, for example, poly (meth)acryl monomers selected from the group consisting of (a) di(meth)acryl containing compounds such as 1,3-butylene glycol diacrylate, 1,4-butanediol diacrylate, 1,6-hexanediol diacrylate, 1,6-hexanediol monoacrylate monomethacrylate, ethylene glycol diacrylate, alkoxylated aliphatic diacrylate, alkoxylated cyclohexane dimethanol diacrylate, alkoxylated hexanediol diacrylate, alkoxylated neopentyl glycol diacrylate, caprolactone modified neopentylglycol hydroxypivalate diacrylate, caprolactone modified neopentylglycol hydroxypivalate diacrylate, cyclohexanedimethanol diacrylate, diethylene glycol diacrylate, dipropylene glycol diacrylate, ethoxylated (10) bisphenol A diacrylate, ethoxylated (3) bisphenol A diacrylate, ethoxylated (30) bisphenol A diacrylate, ethoxylated (4) bisphenol A diacrylate, hydroxypivalaldehyde modified trimethylolpropane diacrylate, neopentyl glycol diacrylate, polyethylene glycol (200) diacrylate, polyethylene glycol (400) diacrylate, polyethylene glycol (600) diacrylate, propoxylated neopentyl glycol diacrylate, tetraethylene glycol diacrylate, tricyclodecanedimethanol diacrylate, triethylene glycol diacrylate, tripropylene glycol diacrylate; (b) tri(meth)acryl containing compounds such as glycerol triacrylate, trimethylolpropane triacrylate, ethoxylated triacrylates (e.g., ethoxylated (3) trimethylolpropane triacrylate, ethoxylated (6) trimethylolpropane triacrylate, ethoxylated (9) trimethylolpropane triacrylate, ethoxylated (20) trimethylolpropane triacrylate), pentaerythritol triacrylate, propoxylated triacrylates (e.g., propoxylated (3) glyceryl triacrylate, propoxylated (5.5) glyceryl triacrylate, propoxylated (3) trimethylolpropane triacrylate, propoxylated (6) trimethylolpropane triacrylate), trimethylolpropane triacrylate, tris(2-hydroxyethyl)isocyanurate triacrylate; (c) higher functionality (meth)acryl containing compounds such as ditrimethylolpropane tetraacrylate, dipentaerythritol pentaacrylate, ethoxylated (4) pentaerythritol tetraacrylate, pentaerythritol tetraacrylate, caprolactone modified dipentaerythritol hexaacrylate; (d) oligomeric (meth)acryl compounds such as, for example, urethane acrylates, polyester acrylates, epoxy acrylates; polyacrylamide analogues of the foregoing; and combinations thereof. Such compounds are widely available from vendors such as, for example, Sartomer Company, Exton, Pa.; UCB Chemicals Corporation, Smyrna, Ga.; and Aldrich Chemical Company, Milwaukee, Wis. Additional useful (meth)acrylate materials include hydantoin moiety-containing poly(meth)acrylates, for example, as described in U.S. Pat. No. 4,262,072 (Wendling et al.).

A preferred crosslinking agent comprises at least three (meth)acrylate functional groups. Preferred commercially available crosslinking agent include those available from Sartomer Company, Exton, Pa. such as trimethylolpropane triacrylate available under the trade designation “SR351”, pentaerythritol triacrylate available under the trade designation “SR444”, dipentaerythritol pentaacrylate available under the trade designation “SR399LV”, ethoxylated (3) trimethylolpropane triacrylate available under the trade designation “SR454”, and ethoxylated (4) pentaerythritol triacrylate, available under the trade designation “SR494”.

A variety of inorganic oxide particles can be used in the hardcoat. The particles are typically substantially spherical in shape and relatively uniform in size. The particles can have a substantially monodisperse size distribution or a polymodal distribution obtained by blending two or more substantially monodisperse distributions. The inorganic oxide particles are typically non-aggregated (substantially discrete), as aggregation can result in precipitation of the inorganic oxide particles or gelation of the hardcoat. The inorganic oxide particles are typically colloidal in size, having an average particle diameter of about 0.001 to about 0.2 micrometers, less than about 0.05 micrometers, and less than about 0.03 micrometers. These size ranges facilitate dispersion of the inorganic oxide particles into the binder resin and provide ceramers with desirable surface properties and optical clarity. The average particle size of the inorganic oxide particles can be measured using transmission electron microscopy to count the number of inorganic oxide particles of a given diameter. Inorganic oxide particles include colloidal silica, colloidal titania, colloidal alumina, colloidal zirconia, colloidal vanadia, colloidal chromia, colloidal iron oxide, colloidal antimony oxide, colloidal tin oxide, and mixtures thereof. The inorganic oxide particles can consist essentially of or consist of a single oxide such as silica, or can comprise a combination of oxides, such as silica and aluminum oxide, or a core of an oxide of one type (or a core of a material other than a metal oxide) on which is deposited an oxide of another type. Silica is a common inorganic particle. The inorganic oxide particles are often provided in the form of a sol containing a colloidal dispersion of inorganic oxide particles in liquid media. The sol can be prepared using a variety of techniques and in a variety of forms including hydrosols (where water serves as the liquid medium), organosols (where organic liquids so serve), and mixed sols (where the liquid medium contains both water and an organic liquid), e.g., as described in U.S. Pat. No. 5,648,407 (Goetz et al.); U.S. Pat. No. 5,677,050 (Bilkadi et al.) and U.S. Pat. No. 6,299,799 (Craig et al.), the disclosure of which is incorporated by reference herein. Aqueous sols (e.g. of amorphous silica) can be employed. Sols generally contain at least 2 wt-%, at least 10 wt-%, at least 15 wt-%, at least 25 wt-%, and often at least 35 wt-% colloidal inorganic oxide particles based on the total weight of the sol. The amount of colloidal inorganic oxide particle is typically no more than 50 wt-% (e.g. 45 wt-%). The surface of the inorganic particles can be “acrylate functionalized” as described in Bilkadi et al. The sols can also be matched to the pH of the binder, and can contain counterions or water-soluble compounds (e.g., sodium aluminate), all as described in Kang et al. '798.

The hardcoat can conveniently be prepared by mixing an aqueous sol of inorganic oxide particles with a free-radically curable binder precursor (e.g., one or more free-radically curable monomers, oligomers or polymers that can participate in a crosslinking reaction upon exposure to a suitable source of curing energy). The resulting composition usually is dried before it is applied, in order to remove substantially all of the water. This drying step is sometimes referred to as “stripping”. An organic solvent can be added to the resulting ceramer composition before it is applied, in order to impart improved viscosity characteristics and assist in coating the ceramer composition onto the substrate. After coating, the ceramer composition can be dried to remove any added solvent, and then can be at least partially hardened by exposing the dried composition to a suitable source of energy in order to bring about at least partial cure of the free-radically curable binder precursor.

The inorganic particles, binder and any other ingredients in the hardcoat are chosen so that the cured hardcoat has a refractive index close to that of the substrate. This can help reduce the likelihood of Moire patterns or other visible interference fringes.

As mentioned above, the hardcoat can be formed from an aqueous coating composition that is stripped to remove water prior to coating, and optionally diluted with a solvent to assist in coating the composition. Those skilled in the art will appreciate that selection of a desired solvent and solvent level will depend on the nature of the individual ingredients in the hardcoat and on the desired substrate and coating conditions. Kang et al. '798 describes several useful solvents, solvent levels and coating viscosities.

If the hardcoat is prepared by combining an aqueous sol of colloidal inorganic oxide particles with the binder precursor, then the sol has a pH such that the particles have a negative surface charge. For example, if the inorganic particles are predominantly silica particles, the sol is alkaline with a pH greater than 7, greater than 8, or greater than 9. The sol may include ammonium hydroxide or the like so that NH⁺₄ is available as a counter cation for particles having a negative surface charge. If surface treatment of the colloidal inorganic oxide particles is desired, a suitable surface treatment agent can be blended into the sol, e.g., as described in Kang et al. '833, the disclosure of which is incorporated by reference herein. The free-radically curable binder precursor is then added to the ceramer composition. The ceramer composition is stripped to remove substantially all of the water. For example, removing about 98% of the water, thus leaving about 2% water in the ceramer composition, has been found to be suitable. As soon as substantially all of the water is removed, an organic solvent of the type described in Kang et al. '798 is typically added in an amount such that the ceramer composition includes from about 5% to about 99% by weight solids (about 10 to about 70%).

The hardcoat composition may comprise various monofunctional fluorinated components, multifunctional fluorinated components, as well as combinations thereof. In at least some embodiments a combination of at least one monofunctional fluorinated component and at least one multifunctional fluorinated components has been found to be preferred.

The total amount of fluorinated components in the hardcoat composition precursor is typically at least 0.5 wt-% (e.g. at least about 1 wt-%, 2 wt-%, 3 wt-%, and 4 wt-%). Preferably, the hardcoat precursor composition comprises at least about 5 wt-% fluorinated components. Particularly for embodiments that employ multifunctional fluorinated components, the hardcoat precursor composition may contain as much as 95 wt-% employ multifunctional fluorinated components. However, as previously described, it is generally more cost effective to employ a minimal concentration of employ fluorinated components that provide the desired low surface energy. Accordingly, the total amount of fluorinated components typically does not exceed 30 wt-% and preferably is present is an amount of no more than about 15 wt-% (e.g. less than about 14 wt-%, 13 wt-%, 12 wt-%, and 111 wt-%).

A variety of fluorinated polymerizable compounds may be employed in the coating compositions of the invention. Such compounds can be represented by the following Formula I:
(R_{f})—[(W)—(R_{A})]_{W} (Formula I)
wherein R_{f} comprises a (per)fluroralkyl group, a (per)fluoroalkylene group, or (per)fluoropolyether group. The (per)fluoropolyether group comprises a (per)fluorinated group such as —(CₚF₂ₚ)—, —(CₚF₂ₚO)—, —(CF(Z))-, —(CF(Z)O)—, —(CF(Z)CₚF₂ₚO)—, —(CₚF₂ₚCF(Z)O)—, —(CF₂CF(Z)O)—, or combinations thereof; W is a linking group; and R_{A} comprises a polymerizable group such as a (meth)acryl group or polymerizable (e.g. hydrolyzable) silane group; and w is 1 or 2.

Various polymerizable silane groups are known in the art. The silane atoms is typically bonded to at least one halogen atoms and/or at least one oxygen atom in which the oxygen atom is preferably a constituent of an acyloxy and/or alkoxy group.

The fluorinated component can be linear, branched, cyclic, or combinations thereof and can be saturated or unsaturated.

The linking group W includes a divalent group selected from an alkylene, arylene, heteroalkylene, or combinations thereof and an optional divalent group selected from carbonyl, carbonyloxy, carbonylimino, sulfonamido, or combinations thereof. W can be unsubstituted or substituted with an alkyl, aryl, halo, or combinations thereof. The W group typically has no more than 30 carbon atoms. In some compounds, the W group has no more than 20 carbon atoms, no more than 10 carbon atoms, no more than 6 carbon atoms, or no more than 4 carbon atoms. For example, W can be an alkylene, an alkylene substituted with an aryl group, or an alkylene in combination with an arylene. W may also be a urethane linkage (i.e. (—OCONH—)

In the (per)fluoropolyether R_{f} repeating units, p is typically an integer of 1 to 10. In some embodiments, p is an integer of 1 to 8, 1 to 6, 1 to 4, or 1 to 3. The group Z is a perfluoroalkyl group, perfluoroether group, perfluoropolyether, or a perfluoroalkoxy group, all of which can be linear, branched, or cyclic. The Z group typically has no more than 12 carbon atoms, no more than 10 carbon atoms, or no more than 9 carbon atoms, no more than 4 carbon atoms, no more than 3 carbon atoms, no more than 2 carbon atoms, or no more than 1 carbon atom. In some embodiments, the Z group can have no more than 4, no more than 3, no more than 2, no more than 1, or no oxygen atoms.

R_{f} can be monovalent or divalent. In some compounds where R_{f} is monovalent, the terminal groups can be (CₚF₂ₚ₊₁)—, (CₚF₂ₚ₊₁O)—, (X′CₚF₂ₚO)—, or (X′CₚF₂ₚ₊₁)— where X′ is hydrogen, chlorine, or bromine and p is an integer of 1 to 10. In some embodiments of monovalent R_{f} groups, the terminal group is perfluorinated and p is an integer of 1 to 10, 1 to 8, 1 to 6, 1 to 4, or 1 to 3.

The (per)fluoropolyether compounds can be represented by the above Formula I wherein R_{f} is (per)fluoropolyether group, R_{A} is a (meth)acryl group or —COCF═CH₂; and w is 1 or 2. Exemplary monovalent R_{f} groups include CF₃O(C₂F₄O)ₙCF₂—, and C₃F₇O(CF(CF₃)CF₂O)ₙCF(CF₃)— wherein n has an average value of 0 to 50, 1 to 50, 3 to 30, 3 to 15, or 3 to 10. Suitable structures for divalent R_{f} (per)fluoropolyether groups include, but are not limited to, —CF₂O(CF₂O)_{q}(C₂F₄O)ₙCF₂—, —(CF₂)₃O(C₄F₈O)ₙ(CF₂)₃—, —CF₂O(C₂F₄O)ₙCF₂—, and —CF(CF₃)(OCF₂CF(CF₃))ₛOCₜF₂ₜO(CF(CF₃)CF₂O)ₙCF(CF₃)—, wherein q has an average value of 0 to 50, 1 to 50, 3 to 30, 3 to 15, or 3 to 10; n has an average value of 0 to 50, 3 to 30, 3 to 15, or 3 to 10; s has an average value of 0 to 50, 1 to 50, 3 to 30, 3 to 15, or 3 to 10; the sum (n+s) has an average value of 0 to 50 or 4 to 40; the sum (q+n) is greater than 0; and t is an integer of 2 to 6.

As synthesized, compounds according to Formula I typically include a mixture of R_{f} groups. The average structure is the structure averaged over the mixture components. The values of q, n, and s in these average structures can vary, as long as the compound has a number average molecular weight of at least about 400. Compounds of Formula I often have a molecular weight (number average) of 400 to 5000, 800 to 4000, or 1000 to 3000.

The perfluoropolyether acrylate compounds (e.g. of Formula I) can be synthesized by known techniques such as described in U.S. Pat. Nos. 3,553,179 and 3,544,537 as well as U.S. Patent Publication No. 2004/0077775, “Fluorochemical Composition Comprising a Fluorinated polymer and Treatment of a Fibrous Substrate Therewith”.

In some embodiments, the polyfunctional perfluoropolyether acrylates comprises a terminal HFPO— group. As used herein “HFPO—” refers to the F(CF(CF₃)CF₂O)ₐCF(CF₃)— of the methyl ester F(CF(CF₃)CF₂O)ₐCF(CF₃)C(O)OCH₃, wherein “a” averages about 6.2, and the methyl ester has an average molecular weight of 1,211 g/mol, that can be prepared according to the method reported in U.S. Pat. No. 3,250,808 (Moore et al.), the disclosure of which is incorporated herein by reference, with purification by fractional distillation. Some of such compounds are further described in U.S. application Ser. No. 11/121,742, filed May 4, 2005; incorporated herein by reference.

Exemplary compounds include for example HFPO—C(O)N(H)C(CH₂OC(O)CH═CH₂)₂CH₂CH₃, HFPO—CO—NHCH(CH₂OCO—CH═CH₂)₂, HFPO—C(O)N(H)CH₂CH(OC(O)CH═CH₂)CH₂OC(O)CH═CH₂, HFPO—CO—NH(CH₂)₃N(CH₂CH₂OCOCH═CH₂)₂, HFPO—CO—NHCH₂CH₂N(—CO—CH═CH₂)(—CH₂CH₂OCOCH═CH₂), and a 1:1 molar ratio adduct of HFPO—C(═O)NHCH₂CH₂CH₂NHCH₃ with TMPTA.

In another embodiment, a (per)fluoropolyether acrylate compound preparable by Michael-type addition of a reactive (per)fluoropolyether with a poly(meth)acrylate, such as the adduct of HFPO—C(O)N(H)CH₂CH₂CH₂N(H)CH₃ with trimethylolpropane triacrylate (TMPTA) may be employed as a polymerizable fluorinated component. Such (per)fluoropolyether acrylate compounds are further described in U.S. patent application Ser. No. 11/009,181, filed Dec. 10, 2004, “Polymerizable Compositions, Methods of Making the Same, and Composite Articles Therefrom”; incorporated herein by reference.

In another embodiment, polymerizable perfluoropolyether urethanes such as described in U.S. patent application Ser. No. 11/087,413, filed Mar. 23, 2005; incorporated herein by reference, may be employed. One representative structure (2) of perfluoropolyether urethanes with multi-acrylates terminal groups of formula (1) is shown below as: 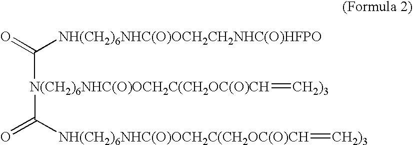
which is the reaction product of the biuret of HDI with one equivalent of HFPO oligomer amidol (F(CF(CF₃)CF₂O)_{6.5}CF(CF₃)C(O)NHCH₂CH₂OH), and further with two equivalents of pentaerythritol triacrylate.

Alternatively, a perfluoropolyether urethane with a mono-acrylate terminal group according to the formula Rᵢ—(NHC(O)XQR_{f})ₘ, —(NHC(O)OQA)ₙ may be employed.

In another embodiment, a perfluoropolyether-substituted urethane acrylate having a monovalent perfluoropolyether moiety of the formula (3A) may be employed:
R_{f}-Q-(XC(O)NHQOC(O)C(R)═CH₂)_{f} (Formula 3A)
where R_{f} is a monovalent perfluoropolyether moiety composed of groups comprising the formula: F(R_{fc}O)ₓC_{d}F_{2d}—, wherein each R_{fc} independently represents a fluorinated alkylene group having from 1 to 6 carbon atoms, each x independently represents an integer greater than or equal to 2, and wherein d is an integer from 1 to 6; a is 2-15; Q is independently a connecting group of valency at least 2 and is selected from the group consisting of a covalent bond, an alkylene, an arylene, an aralkylene, an alkarylene, a straight or branched chain or cycle-containing connecting group optionally containing heteroatoms such as O, N, and S and optionally a heteroatom-containing functional group such as carbonyl or sulfonyl, and combinations thereof; X is independently O, S or NR, where R is H or lower alkyl of 1 to 4 carbon atoms and f is 1-5.

One preferred perfluoropolyether-substituted urethane (meth)acrylate that meets the description of formula (3A) is described more specifically in formula (3B):
HFPO-Q-(XC(O)NHQOC(O)C(R)═CH₂)_{f} (Formula 3B)
where HFPO is F(CF(CF₃)CF₂O)ₐCF(CF₃)—; a is 2-15; Q is independently a connecting group of valency at least 2 and is selected from the group consisting of a covalent bond, an alkylene, an arylene, an aralkylene, an alkarylene, a straight or branched chain or cycle-containing connecting group optionally containing heteroatoms such as O, N, and S and optionally a heteroatom-containing functional group such as carbonyl or sulfonyl, and combinations thereof; X is independently O, S or NR, where R is H or lower alkyl of 1 to 4 carbon atoms and f is 1-5. Two preferred HFPO-substituted urethane acrylates that can be utilized include: HFPO—C(O)NHC₂H₄OC(O)NHC₂H₄OC(O)C(CH₃)═CH₂ and HFPO—C(O)NHC(C₂H₅)(CH₂OC(O)NHC₂H₄OC(O)C(CH₃)═CH₂)₂.

In another embodiment of the present invention, one or more perfluoropolyether urethanes having a monovalent perfluoropolyether moiety of formula (4) is employed:
Rᵢ—(NHC(O)XQR_{f})ₘ, —(NHC(O)OQ(A)ₚ)ₙ, —(NHC(O)XQG)ₒ, —(NCO)_{q} (Formula 4)
wherein Rᵢ is the residue of a multi-isocyanate; X is independently O, S or NR, where R is H or lower alkyl of 1 to 4 carbon atoms; R_{f} is a monovalent perfluoropolyether moiety composed of groups comprising the formula: F(R_{fc}O)ₓC_{d}F_{2d}—, wherein each R_{fc} independently represents a fluorinated alkylene group having from 1 to 6 carbon atoms, each x independently represents an integer greater than or equal to 2, and wherein d is an integer from 1 to 6; Q is independently a connecting group of valency at least 2 and is selected from the group consisting of a covalent bond, an alkylene, an arylene, an aralkylene, an alkarylene, a straight or branched chain or cycle-containing connecting group optionally containing heteroatoms such as O, N, and S and optionally a heteroatom-containing functional group such as carbonyl or sulfonyl, and combinations thereof; A is a (meth)acryl functional group —XC(O)C(R₂)═CH₂, where R₂ is a lower alkyl of 1 to 4 carbon atoms or H or F; G is selected from the group consisting of an alkyl, an aryl, an alkaryl and an aralkyl, wherein G optionally contains heteroatoms such as O, N, and S and optionally has heteroatom-containing functional groups such as carbonyl and sulfonyl and combinations of heteroatoms and heteroatom-containing functional groups; and G optionally contains pendant or terminal reactive groups selected from the group consisting of (meth)acryl groups, vinyl groups, allyl groups and —Si(OR₃)₃ groups, where R₃ is a lower alkyl of 1 to 4 carbon atoms; wherein G also optionally has fluoroalkyl or perfluoroalkyl groups; m is at least 1; n is at least 1; o is 0 or greater; p is 2 to 6; q is 0 or greater; (m+n+o+q)=N_{NCO}, where N_{NCO} is the number of isocyanate groups originally appended to Rᵢ; and the quantity (m+n+o)/N_{NCO} is greater than or equal to 0.67, and in which each unit referred to by the subscripts m, n, o, and q is attached to an Rᵢ unit. Preferably R_{fc} is —CF(CF₃)CF₂—.

The monoalcohol, monothiol or monoamine HXQG used in making materials of formula (4) may include materials such as C₄F₉SO₂N(CH₃)CH₂CH₂OH, H₂NCH₂CH₂CH₂(SiOCH₃)₃, HSCH₂CH₂CH₂Si(OCH₃)₃, and HEA (“hydroxyethylacrylate”).

In still another embodiment, one or more perfluoropolyether urethanes of formula (5) are employed:
(Rᵢ)_{c}—(NHC(O)XQR_{f})ₘ, —(NHC(O)OQ(A)ₚ)ₙ, —(NHC(O)XQG)ₒ, (R_{f}(Q)(XC(O)NH)_{y})_{z}—, —NHC(O)XQ D(QXC(O)NH)ᵤ)ₛ—, D₁(QXC(O)NH)_{y})_{zz} —NHC(O)OQ(A)ₜQ₁Q(A)ₜOC(O)NH))ᵥ—, —(NCO)_{w} (Formula 5)
wherein Rᵢ is the residue of a multi-isocyanate; c is 1 to 50; X is independently O, S or NR, where R is H or lower alkyl; R_{f} is a monovalent perfluoropolyether moiety composed of groups comprising the formula: F(R_{fc}O)ₓC_{d}F_{2d}—, each R_{fc} independently represents a fluorinated alkylene group having from 1 to 6 carbon atoms and each x independently represents an integer greater than or equal to 2 and wherein d is an integer from 1 to 6; Q is independently a connecting group of valency at least 2 and is selected from the group consisting of a covalent bond, an alkylene, an arylene, an aralkylene, an alkarylene, a straight or branched chain or cycle-containing connecting group optionally containing heteroatoms such as O, N, and S and optionally a heteroatom-containing functional group such as carbonyl or sulfonyl, and combinations thereof; A is a (meth)acryl functional group having the chemical formula: (—XC(O)C(R₂)═CH₂), where R₂ is a lower alkyl of 1 to 4 carbon atoms or H or F; G is selected from the group consisting of an alkyl, an aryl, an alkaryl and an aralkyl, wherein G optionally contains heteroatoms such as O, N, and S and optionally has heteroatom-containing functional groups such as carbonyl and sulfonyl and combinations of heteroatoms and heteroatom-containing functional groups; and wherein G optionally contains pendant or terminal reactive groups selected from the group consisting of (meth)acryl groups, vinyl groups, allyl groups and —Si(OR₃)₃ groups, where R₃ is a lower alkyl of 1 to 4 carbon atoms; wherein G also optionally has fluoroalkyl or perfluoroalkyl groups; D is selected from the group consisting of an alkylene, an arylene, an alkarylene, a fluoroalkylene, a perfluoroalkylene and an aralkylene and optionally contains heteroatoms such as O, N, and S; D₁ is selected from the group consisting of an alkyl, an aryl, an alkaryl, a fluoroalkyl, a perfluoroalkyl and an aralkyl group and optionally contains heteroatoms such as O, N, and S; Q₁ is a connecting group defined in the same way as Q; m or z is at least 1; n or v is at least 1; y is independently 2 or greater; o, s, v, w, z and zz are 0 or greater; (m+n+o+[(u+1)s]+2v+w+yz+y(zz))=cN_{NCO}, where N_{NCO} is the number of isocyanate groups originally appended to Rᵢ; the quantity (m+n+o+([(u+1)s]+2v+yz+y(zz))/(cN_{NCO}) is greater than or equal to least 0.75; p is 2 to 6; t is 1 to 6; and u is independently 1 to 3; in which each unit referred to by the subscripts m, n, o, s, v, w, z and zz is attached to an Rᵢ unit; and preferably R_{fc} is —CF(CF₃)CF₂—.

As an alternative to fluorinated components comprising (per)fluoropolyether moieties, (per)fluoroalkyl(meth)acrylates can be used. Preferred fluoroalkyl (meth)acrylates include fluoroalkyl groups having at least 2, and more preferably at least 3 carbon atoms. Although the number of carbon atoms may range up to 12 or greater, the number of carbon atoms of the fluoroalkyl group is preferably no greater than about 6.

As yet another alternative, the fluorinated component may comprise one of various fluoro-silane components such as described in US2003/0168783; incorporated herein by reference. In one aspect the fluorinated component may comprise a fluorinated siloxane as described in U.S. Pat. No. 5,851,674 prepared by applying a coating composition comprising a fluorinated silane of the following formula:
R_{f}—R₁—SiX₃₋ₓR²ₓ
wherein:
R_{f} is a (per)fluorinated group optionally containing one or more heteroatoms;
R₁ is a divalent alkylene group, arylene group, or mixture thereof, substituted with one or more heteroatoms or functional groups, containing about 2 to about 16 carbon atoms;
R₂ is a lower alkyl group;
X is a halide, a lower alkoxy group, or an acyloxy group; and
x is 0 or 1.

The hardcoat composition may comprise a fluorinated compatibilizer to improve compatibility between the hydrocarbon-based hard coat composition or ceramers and the fluorinated compound (e.g. HFPO derivative). The compatibilizer may be added at an amount ranging from 2 and 15 weight percent and more preferably between about 2 to 10 weight percent, of the overall dry solids. The compatibilizer may be present in an amount at least 3 and preferably at least 5 times the amount of the HFPO mono- or multi-(meth)acryl compound.

The free-radically reactive fluoroalkyl or fluoroalkylene group-containing compatibilizers are of the respective chemical formula: R_{f}Q(X)ₙ and (X)ₙQR_{f2}Q(X)ₙ), where R_{f} is a fluoroalkyl, R_{f2} is a fluoroalkylene, Q is a connecting group comprising an alkylene, arylene, arylene-alkylene, or alkylene-arylene group and may comprise a straight or branched chain connecting group which may contain heteroatoms such as O,N, and S,X is a free-radically reactive group selected from (meth)acryl, —SH, allyl, or vinyl groups and n is 1 to 3. Typical Q groups include: —SO₂N(R)CH₂CH₂—; —SO₂N(CH₂CH₂)₂—; —(CH₂)ₘ—; —CH₂O(CH₂)₃—; and —C(O)N(R)CH₂CH₂—, where R is H or lower alkyl of 1 to 4 carbon atoms and m is 1 to 6. Preferably the fluoroalkyl or fluoroalkylene group is a perfluoroalkyl or perfluoroalkylene group.

In one preferred embodiment, the compatibilizer is a perfluoroalkyl or perfluoroalkylene-substituted compatibilizer having a carbon chain of at least five carbon atoms attached to the acrylate portion and contains at least 30 weight percent of fluorine. One preferred class of fluoroalkyl- or fluoroalkylene-substituted compatibilizers meeting these criteria for use in the composition of the hard coat layer 18 is the perfluorobutyl-substituted acrylate compatibilizers. Exemplary, non-limiting perfluorobutyl-substituted acrylate compatibilizers meeting these criteria and useful in the present invention include one or more of C₄F₉SO₂N(CH₃)CH₂CH₂OC(O)CH═CH₂, C₄F₉SO₂N(CH₂CH₂OC(O)CH═CH₂)₂, or C₄F₉SO₂N(CH₃)CH₂CH₂OC(O)C(CH₃)═CH₂.

Other non-limiting examples of preferred fluoroalkyl-substituted compatibilizer that may be utilized include: 1H,1H,2H,2H-perfluorodecyl acrylate, available from Lancaster Synthesis of Windham, N.H. Numerous other (meth)acryl compounds with perfluoroalkyl moieties that may also be utilized in the composition of the hard coat layer 18 are mentioned in U.S. Pat. No. 4,968,116, to Hulme-Lowe et al., and in U.S. Pat. No. 5,239,026 (including perfluorocyclohexylmethyl methacrylate)), to Babirad et al., herein incorporated by reference. Other fluorochemical (meth)acrylates that meet these criteria and may be utilized include, for example, 2,2,3,3,4,4,5,5-octafluorohexanediol diacrylate and ω-hydro 2,2,3,3,4,4,5,5-octafluoropentyl acrylate (H—C₄F₈—CH₂O—C(O)—CH═CH₂). Other fluorochemical (meth)acrylates that may be used alone, or as mixtures, are described in U.S. Pat. No. 6,238,798, to Kang et al., herein incorporated by reference.

To facilitate curing, polymerizable compositions according to the present invention may further comprise at least one free-radical thermal initiator and/or photoinitiator. Typically, if such an initiator and/or photoinitiator are present, it comprises less than about 10 percent by weight, more typically less than about 5 percent of the polymerizable composition, based on the total weight of the polymerizable composition. Free-radical curing techniques are well known in the art and include, for example, thermal curing methods as well as radiation curing methods such as electron beam or ultraviolet radiation. Further details concerning free radical thermal and photopolymerization techniques may be found in, for example, U.S. Pat. No. 4,654,233 (Grant et al.); U.S. Pat. No. 4,855,184 (Klun et al.); and U.S. Pat. No. 6,224,949 (Wright et al.).

Useful free-radical photoinitiators include, for example, those known as useful in the UV cure of acrylate polymers. Such initiators include benzophenone and its derivatives; benzoin, alpha-methylbenzoin, alpha-phenylbenzoin, alpha-allylbenzoin, alpha-benzylbenzoin; benzoin ethers such as benzil dimethyl ketal (commercially available under the trade designation “IRGACURE 651” from Ciba Specialty Chemicals Corporation of Tarrytown, N.Y.), benzoin methyl ether, benzoin ethyl ether, benzoin n-butyl ether; acetophenone and its derivatives such as 2-hydroxy-2-methyl-1-phenyl-1-propanone (commercially available under the trade designation “DAROCUR 1173” from Ciba Specialty Chemicals Corporation) and 1-hydroxycyclohexyl phenyl ketone (commercially available under the trade designation “IRGACURE 184”, also from Ciba Specialty Chemicals Corporation); 2-methyl-1-[4-(methylthio)phenyl]-2-(4-morpholinyl)-1-propanone commercially available under the trade designation “IRGACURE 907”, also from Ciba Specialty Chemicals Corporation); 2-benzyl-2-(dimethylamino)-1-[4-(4-morpholinyl)phenyl]-1-butanone commercially available under the trade designation “IRGACURE 369” from Ciba Specialty Chemicals Corporation); aromatic ketones such as benzophenone and its derivatives and anthraquinone and its derivatives; onium salts such as diazonium salts, iodonium salts, sulfonium salts; titanium complexes such as, for example, that which is commercially available under the trade designation “CGI 784 DC”, also from Ciba Specialty Chemicals Corporation); halomethylnitrobenzenes; and mono- and bis-acylphosphines such as those available from Ciba Specialty Chemicals Corporation under the trade designations “IRGACURE 1700”, “IRGACURE 1800”, “IRGACURE 1850”, “IRGACURE 819” “IRGACURE 2005”, “IRGACURE 2010”, “IRGACURE 2020” and “DAROCUR 4265”. Combinations of two or more photoinitiators may be used. Further, sensitizers such as 2-isopropyl thioxanthone, commercially available from First Chemical Corporation, Pascagoula, Miss., may be used in conjunction with photoinitiator(s) such as “IRGACURE 369”.

Those skilled in the art appreciate that the coating compositions can contain other optional adjuvants, such as, surfactants, antistatic agents (e.g., conductive polymers), leveling agents, photosensitizers, ultraviolet (“UV”) absorbers, stabilizers, antioxidants, lubricants, pigments, dyes, plasticizers, suspending agents and the like. If an antistatic feature is desired, the antistatic agents can be incorporated into any of the functional coating layers or be applied as a separate layer.

The hardcoat coating composition preferably includes a solvent that assists in coating. Although fluorinated solvents could optionally be employed alone or in combination with an organic solvent, the ingredients of the hardcoat are preferably sufficiently soluble in non-fluorinated solvent. Thus, the hardcoat coating composition can advantageously be free of fluorinated solvents. Preferred solvents include ketones such as methyl ethyl ketone (MEK), methyl isobutylene ketone (MIBK), and methyl propyl ketone (MPK); and acetates such as ethyl acetate, at a concentration to obtain the intended coating thickness (e.g. 2% to 3% solids). Any adjuvants, as previously described, are typically added after dissolution with the solvent.

The easy-clean hardcoat composition is typically free of hydrophilic ingredients (e.g. monomers) since the inclusion of such tends to reduce anti-soiling properties as well as stain certain media (e.g. substrates). Hydrophilic components are also susceptible to degradation upon exposure to aqueous based cleaning agents.

Objects and advantages of this invention are further illustrated by the following examples, but the particular materials and amounts thereof recited in these examples, as well as other conditions and details, should not be construed to unduly limit this invention.

### EXAMPLES

Test Methods

1. Contact Angle—The coatings were rinsed for 1 minute by hand agitation in IPA before being subjected to measurement of water and hexadecane contact angles. Measurements were made using as-received reagent-grade hexadecane (Aldrich) and deionized water filtered through a filtration system obtained from Millipore Corporation (Billerica, Mass.), on a video contact angle analyzer available as product number VCA-2500XE from AST Products (Billerica, Mass.). Reported values are the averages of measurements on at least three drops measured on the right and the left sides of the drops, and are shown in Table 2. Drop volumes were 5 μL for static measurements and 1-3 μL for advancing and receding. For hexadecane, only advancing and receding contact angles are reported because static and advancing values were found to be nearly equal.

2. Durability Test—The abrasion resistance of the cured films was tested cross-web to the coating direction by use of a mechanical device capable of oscillating steel wool fastened to a stylus (by means of a rubber gasket) across the film's surface. The stylus oscillated over a 10 cm wide sweep width at a rate of 3.5 wipes/second wherein a “wipe” is defined as a single travel of 10 cm. The stylus had a flat, cylindrical geometry with a diameter of 6 mm. The device was equipped with a platform on which weights were placed to increase the force exerted by the stylus normal to the film's surface. The steel wool was obtained from Rhodes-American a division of Homax Products, Bellingham, Wash. under the trade designation “#0000-Super-Fine” and was used as received. A single sample was tested for each example, with the weight in grams applied to the stylus and the number of wipes employed during testing reported.

3. Haze and Transmission values of the coated films were measured by use of BYK Gardner Haze-Clarity-Transmission meter. The values are reported as percent.

Ingredients

F(CF(CF₃)CF₂O)aCF(CF₃)COOCH₃ wherein a averages about 6.3, with an average molecular weight of 1,211 g/mol, and which can be prepared according to the method reported in U.S. Pat. No. 3,250,808 (Moore et al.), the disclosure of which is incorporated herein by reference, with purification by fractional distillation.

Trimethylolpropane triacrylate (“TMPTA”) was obtained from Sartomer Company, Exton, Pa. under the trade designation “SR351” (AC-1)

A mixture of pentaerythritol tri- and tetra-acrylate was obtained from Sartomer Company under the trade designation “SR295”. (AC-2)

Triethyleneglycol diacrylate was obtained from Sartomer Company under the trade designation “SR306”. (AC-3)

ω-hydro 2,2,3,3,4,4,5,5-octafluoropentyl acrylate (H—C₄F₈—CH₂O—C(O)—CH═CH₂) was obtained from Oakwood Products, West Columbia, S.C. (FC-6)

N-methyl-1,3-propane-diamine, 2-amino-2-ethyl-1,3-propane diol and 2-amino-1,3-propane diol were obtained from Sigma-Aldrich, Milwaukee, Wis.

Acryloyl chloride was obtained from Sigma-Aldrich.

The UV photoinitiator used was obtained from Ciba Specialty Products, Terrytown, N.Y. under the trade designation “Darocur 1173”.

The “non-fluorinated hardcoat composition” used in the examples was made as described in column 10, line 25-29 and Example 1 of U.S. Pat. No. 5,677,050 to Bilkaldi et al.

The following describes the preparation of protective films comprising a dual-layer hardcoat comprising an easy-clean hardcoat disposed on a non-fluorinated hardcoat, wherein the non-fluorinated hardcoat is disposed on a transparent substrate having low haze.

1. Preparation of HFPOC(O)—NH—CH₂CH₂—OH Starting Material (i.e. HFPO-AE-OH)

HFPO—C(O)OCH₃ (Mw=1211 g/mole, 50.0 g) was placed in 200 ml round bottom flask. The flask was purged with nitrogen and placed in a water bath to maintain a temperature of 50° C. or less. To this flask was added 3.0 g (0.045 mol) of 2-aminoethanol (obtained from Aldrich). The reaction mixture was stirred for about 1 hr, after which time an infrared spectrum of the reaction mixture showed complete loss of the methyl ester band at 1790 cm⁻¹ and the presence of the strong amide carbonyl stretch at 1710 cm⁻¹. Methyl t-butyl ether (MTBE, 200 ml) was added to the reaction mixture and the organic phase was extracted twice with water/HCl (˜5%) to remove unreacted amine and methanol. The MTBE layer was dried with MgSO₄. The MTBE was removed under reduced pressure to yield a clear, viscous liquid. ¹H Nuclear magnetic resonance spectroscopy (NMR) and infrared spectroscopy (IR) confirmed the formation of the above-identified compound.

Preparation of Monofunctional Perfluoropolyether Acrylate (FC-1) HFPO—C(O)N(H)CH2CH₂OC(O)CH═CH2 (HFPO-AEA)

HFPO-AE-OH (600 g) was combined with ethyl acetate (600 g) and triethylamine (57.9 g) in a 3-neck round bottom flask that was fitted with a mechanical stirrer, a reflux condenser, addition funnel, and a hose adapter that was connected to a source of nitrogen gas. The mixture was stirred under a nitrogen atmosphere and was heated to 40° C. Acryloyl chloride (51.75 g) was added dropwise to the flask from the addition funnel over about 30 minutes. The mixture was stirred at 40° C. overnight. The mixture was then allowed to cool to room temperature, diluted with 300 mL of 2N aqueous HCl and transferred to a separatory funnel. The aqueous layer was removed and the ethyl acetate layer was extracted with another 300 ml portion of 2N HCl. The organic phase was then extracted once with 5 wt-% aqueous NaHCO₃ separated, dried over MgSO₄ and filtered. Removal of the volatile components using a rotary evaporator resulted in 596 g of product (93% yield). ¹H NMR and IR spectroscopy confirmed the formation of the above-identified compound.

2. Preparation of HFPOC(O)—NH—CH₂CH₂—O—CH₂CH₂—OH Starting Material (i.e. HFPO-AEE-OH)

HFPO—C(O)OCH₃ (Mw=1211 g/mole. 51.0 g) was placed in a 200 ml round bottom flask. The flask was purged with nitrogen and placed in a water bath to maintain a temperature of 50° C. or less. To this flask was added 5.35 g (0.045 mol) of 2-aminoethoxy ethanol (obtained from Aldrich). The reaction mixture was stirred for about 1 hr, after which time an infrared spectrum of the reaction mixture showed complete loss of the methyl ester band at 1790 cm⁻¹ and the presence of the strong amide carbonyl stretch at 1710 cm⁻¹. Methyl t-butyl ether (200 ml) was added to the reaction mixture and the organic phase was extracted twice with water/HCl (˜15%) to remove unreacted amine and methanol. The MTBE layers were combined and dried with MgSO₄. The MTBE was removed under reduced pressure to yield a clear, viscous liquid. Further drying at 0.1 mm Hg at room temperature for 16 hrs, resulted in 48 g (90% yield). ¹H NMR and IR spectroscopy confirmed the formation of the above-identified compound.

Preparation of Monofunctional Perfluoropolyether Acrylate (FC-2) HFPO—C(O)N(H)CH₂CH₂OCH₂CH₂OC(O)CH═CH₂

HFPO-AEE-OH (25 g) was combined with ethyl acetate (200 g) and triethylamine (5 g) in a 3-neck round bottom flask that was fitted with a mechanical stirrer, a reflux condenser, addition funnel, and a hose adapter that was connected to a source of nitrogen gas. The mixture was stirred under a nitrogen atmosphere and was heated to 40° C. Acryloyl chloride (5.5 g) was added drop wise to the flask from the addition funnel over about 30 minutes. The mixture was stirred at 40° C. overnight. The mixture was then allowed to cool to room temperature, diluted with 300 mL of 2N aqueous HCl and transferred to a separatory funnel. The aqueous layer was removed and the ethyl acetate layer was extracted with another 300 ml portion of 2N HCl. The organic phase was then extracted once with 5 wt-% aqueous NaHCO₃ separated, dried over MgSO₄ and filtered. Removal of the volatile components using a rotary evaporator afforded the product. ¹H NMR and IR spectroscopy confirmed the formation of the above-identified compound.

3. Preparation of Perfluoropolyether Amide-Amine Starting Material HFPO—C(O)N(H)CH₂CH₂CH₂N(H)CH₃

To a 1 liter round bottom was charged 291.24 g (0.2405 moles) of the HFPO—C(O)OCH₃ (i.e. Mw 1211 g/mole) and 21.2 g (0.2405 moles) of N-methyl-1,3 propanediamine, both at room temperature, to form a cloudy solution. The flask was swirled and the solution temperature rose to 45° C., clearing to a water white liquid that was heated overnight at 55° C. The solution was then placed on a rotary evaporator at 75° C. and 28 inches Hg of vacuum to remove the methanol and yielded 301.88 g (99%) of a slightly yellow, viscous liquid, which was characterized by NMR methods to be the above-identified compound at 98% purity.

Preparation of Polyfunctional Perfluoropolyether Acrylate (FC-3) Michael addition adduct of HFPO—C(O)N(H)CH₂CH₂CH₂N(H)CH₃ with TMPTA in a 1:1 molar ratio

A 250 mL round bottom was charged with 4.48 g (15.2 mmoles, based on a nominal MW of 294) of TMPTA, 4.45 g of tetrahydrofuran (THF), and 1.6 mg of phenothiazine (obtained from Sigma-Aldrich) and placed in an oil bath at 55° C. Next, in a 100 mL jar was dissolved 20 g (15.78 mmole, Mw 1267.15) HFPO—C(O)N(H)CH₂CH₂CH₂N(H)CH₃ in 32 g THF. This solution was placed in a 60 mL dropping funnel with pressure equalizing sidearm, the jar rinsed with ˜3 mL of THF which was also added to the dropping funnel, and the contents of the funnel were added over 38 min, under an air atmosphere to the TMPTA/THF/phenothiazine mixture. The reaction was cloudy at first, but cleared at about 30 min. Twenty minutes after the addition was complete, the reaction flask was placed on a rotary evaporator at 45-55° C. under 28 inches of vacuum to yield 24.38 g of a clear, viscous yellow liquid that was characterized by NMR and HPLC/mass spectroscopy as the above-identified compound.

4. Preparation of HFPO—C(O)N(H)C(CH₂OH)₂CH₂CH₃ Starting Material

To a 500 ml 3 necked flask equipped with stir bar, reflux condenser, and heating bath was charged 11.91 g (0.1 mol) H₂NC(CH₂OH)₂CH₂CH₃ (obtained from Sigma-Aldrich) and 60 g THF. Next via dropping funnel was added 121.1 g (0.1 mol) HFPO—C(O)OCH₃ over about 80 min at a heating bath temperature of about 85° C. The reaction was cloudy at first, but became clear about 1 h into the reaction. After addition was complete, the heating bath was shut off and the reaction was allowed to cool for three days. The material was concentrated at 55° C. under aspirator vacuum to yield 130.03 g of a light colored syrup. NMR analysis showed the product to be an 87:13 mixture of the structures I to II as follows: 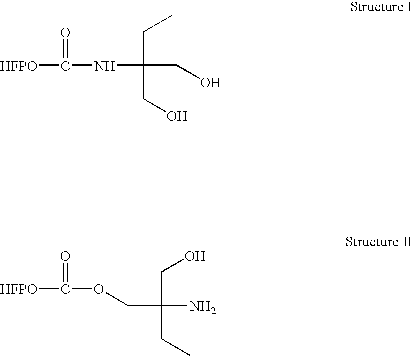
Preparation of Polyfunctional Perfluoropolyether Acrylate HFPO—C(O)N(H)C(CH₂OC(O)CH═CH₂)₂CH₂CH₃ (FC-4)
To a 250 ml 3 necked round bottom equipped with overhead stirrer was charged 65 g (0.05 mol) of HFPO—C(O)N(H)C(CH₂OH)₂CH₂CH₃, the product mixture generated above, 12.65 g (0.125 mol) triethylamine and 65 g ethyl acetate. To the flask at room temperature was added 11.31 g(0.125 mol) acryloyl chloride using a pressure-equalizing dropping funnel over 12 min, with the reaction temperature rising from 25 to a maximum of 40° C. The funnel was rinsed with 5 g additional ethyl acetate and the rinse was added to the reaction that was then placed in a 40° C. bath and allowed to react for 2 hours and 10 min additional time. The organic layer was then successively washed with 65 g 2% aqueous sulfuric acid, 65 g 2% aqueous sodium bicarbonate, and 65 g water, dried over anhydrous magnesium sulfate, filtered, treated with 16 mg methoxyhydroquinone (MEHQ), and concentrated on a rotary evaporator at 45° C. to yield 62.8 g of crude product. Next 35 g of this material was chromatographed on 600 ml of silica gel (SX0143U-3, Grade 62, 60-200 mesh, EM Science) using 25:75 ethyl acetate: heptane as an eluent. The first two fractions were 250 ml in volume, the remaining fractions were 125 ml in volume. Fractions 4-10 were combined, 8 mg MEHQ was added to the fractions, which were concentrated on a rotary evaporator at 55° C. to provide 25.36 g of product that was analyzed by NMR, and found to be an 88:12 mixture of the structures III to IV. 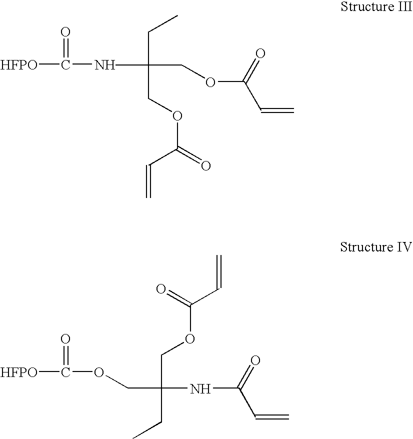
5. Preparation of HFPO—C(O)N(H)C(CH₂OH)₂H Starting Material
By a method similar to the preparation of HFPO—C(O)N(H)C(CH₂OH)₂CH₂CH₃, 106.74 g (0.088 mol) HFPO—C(O)CH₃ was reacted with 8.03 g (0.088 mol) 2-amino-1,3-propanediol in 51 g THF to provide a product that was 93:7 amide diol: ester amino-alcohol.
Preparation of Polyfunctional Perfluoropolyether Acrylate (FC-5) HFPO—C(O)N(H)C(CH₂OC(O)CH═CH₂)₂H
In a method similar to the preparation of HFPO—C(O)N(H)C(CH₂OC(O)CH═CH₂)₂CH₂CH₃, 50 g (0.3936 mol) HFPO—C(O)N(H)C(CH₂OH)₂H was reacted with 8.55 g (0.0945 mol) acryloyl chloride and 9.56 g (0.946 mol) triethylamine in 100 g of ethyl acetate, to provide after workup and chromatography, the 93:7 mixture of diacrylate and acrylamide-acrylate.
Preparation of the Coating Solutions:
Substrates were coated with the polymerizable compositions using materials and amounts by weight as reported in Table 1A and 1B. All polymerizable components were diluted to 10 percent by weight total solids in methyl ethyl ketone. Two weight percent based on solids of the photoinitiator Darocur 1173 was included in the polymerizable compositions using a 10 percent solids photoinitiator solution in methyl ethyl ketone. The photoinitiator was added before dilution of the mixture to the final concentration of the coating solution. Dilution to the solids concentration (i.e. 2 wt-% or 2.5 wt-%) was achieved using methyl isobutyl ketone. The final solids concentration of the coating solution for each Example is set forth in Tables 1A and 1B.
Coating, Drying, Curing Process
The substrate was prepared from a transparent polyethylene terephthalate (PET) film obtained from e.i. DuPont de Nemours and Company, Wilmington, Del. under the trade designation “Melinex 618” having a thickness of 5.0 mils and a primed surface. The non-fluorinated hardcoat composition was coated onto the primed surface and cured in a UV chamber having less than 50 parts per million (ppm) oxygen. The UV chamber was equipped with a 600 watt H-type bulb from Fusion UV systems, Gaithersburg Md., operating at full power.
The easy-clean hardcoat was applied to the Melinex 618 film with a metered, precision die coating process. The easy-clean hardcoat was diluted in IPA to 30 wt-% solids and coated onto the 5-mil PET backing to achieve a dry thickness of 5 microns. A flow meter was used to monitor and set the flow rate of the material from a pressurized container. The flow rate was adjusted by changing the air pressure inside the sealed container which forces liquid out through a tube, through a filter, the flow meter and then through the die. The dried and cured film was wound on a take up roll and used as the input backing for the coating solutions described below.

The easy-clean hardcoat coating and drying parameters for were as follows:

| | |
|---|---|
| Coating width: | 6″ (15 cm) |
| Web Speed: | 30 feet (9.1 m) per minute |
| Solution % Solids: | 30.2% |
| Filter: | 2.5 micron absolute |
| Pressure Pot: | 1.5 gallon capacity (5.7 1) |
| Flow rate: | 35 g/min |
| Wet Coating Thickness: | 24.9 microns |
| Dry Coating Thickness: | 4.9 microns |
| Conventional Oven Temps: | 140° F. (60° C.) Zone 1 |
| | 160° F. (53° C.) Zone 2 |
| | 180° F. (82° C.) Zone 3 |
| Length of oven | 10 feet (3 m) |

TABLE 1A
Coating Formulations Comprising Perfluoropolyether (meth)acrylate
fluorinated component(s) (wt-% solids)

| | Coating | | | | | |
|---|---|---|---|---|---|---|
| | Solution Wt- | | | | | |
| Example | % Solids | AC-1 | FC-1 | FC-3 | FC-6 | Substrate |
| 1a | 2 | 90 | 2 | | 8 | S-1 |
| 2a | 2 | 85 | 5 | | 10 | S-1 |
| 4a | 2.5 | 85 | | 10 | 5 | S-1 |
| 7a | 2.5 | 85 | 5 | 5 | 5 | S-1 |
| 8a | 2.5 | 90 | | 10 | | S-1 |
| 9a | 2.5 | 95 | 5 | | | S-1 |

TABLE 1B
Coating Formulations Comprising Perfluoropolyether (meth)acrylate
fluorinated component(s) (wt-% solids)

| | Coating | | | | | |
|---|---|---|---|---|---|---|
| | Solution | | | | | |
| | Wt-% | | | | | |
| Example | Solids | AC-1 | FC-1 | FC-2 | FC-5 | FC-4 |
| 16a | 2.5 | 95 | | | | 5 |
| 19a | 2.5 | 95 | | | 5 | |
| 20a | 2 | 85 | | 5 | 10 FC-6 | |
| | | | | | (instead | |
| | | | | | of FC-5) | |

TABLE 2
Contact Angle Testing

| | | | | Hexadecane Contact | | Haze | Trans |
|---|---|---|---|---|---|---|---|
| | Water Contact Angle (degrees) | | | Angle | | before | before |
| Example | Static | Advancing | Receding | Advancing | Receding | testing | testing |
| 1a | 98 | 108 | 76 | 51 | 39 | 0.22 | 93.1 |
| 2a | 106 | 119 | 92 | 63 | 55 | 0.53 | 92.5 |
| 4a | 102 | 115 | 74 | 63 | 53 | 0.69 | 96 |
| 7a | 107 | 119 | 86 | 67 | 58 | 0.55 | 99.6 |
| 8a | 103 | 115 | 75 | 64 | 54 | 0.94 | 99.4 |
| 9a | 104 | 115 | 88 | 60 | 51 | 0.56 | 99.6 |
| 16a | 108 | 118 | 97 | 65 | 59 | 0.54 | 99.6 |
| 19a | 106 | 119 | 96 | 65 | 57 | 0.46 | 99.6 |
| 20a | 105 | 118 | 91 | 63 | 54 | 0.28 | 93.2 |

TABLE 4
Steel Wool Durability Test Results

| | | | | After Durability | |
|---|---|---|---|---|---|
| | | Initial | | Testing | |
| | | | Ink | | Ink |
| | | Ink | Beads | Ink | Beads |
| | No. of | repellency | Up | repellency | Up |
| Example | Wipes | Yes/No | Yes/No | Yes/No | Yes/No |
| 2a | 500 | Y | Y | Y | Y |
| 4a | 500 | Y | Y | Y | Y |
| 7a | 50 | Y | Y | Y | Y |
| 8a | 100 | Y | Y | Y | Y |
| 9a | 500 | Y | Y | Y | Y |
| 16a | 500 | Y | Y | Y | Y |
| 19a | 500 | Y | Y | Y | Y |
| 20a | 500 | Y | Y | Y | Y |

200 g weight for all steel wool durability testing

The results show that the protective film article has sufficiently low haze to be suitable for use on various internal components.

The same general procedure of preparing a protective film having a non-fluorinated hardcoat disposed on a substrate and an easy-clean hardcoat disposed on the non-fluorinate hardcoat was repeated using perfluoropolyether urethane acrylate as a fluorinated component.

A 500 ml round bottom 2-necked flask equipped with magnetic stir bar was charged with 25.00 g (0.131 eq, 191 EW) Des N100, 26.39 g (0.0196 eq, 1344 EW) F(CF(CF₃)CF₂O)_{6.85} CF(CF₃)C(O)NHCH₂CH₂OH, and 109.62 g MEK, and was swirled to produce a homogeneous solution. The flask was placed in an 80 degrees Celsius bath, charged with 2 drops of dibutyltin dilaurate catalyst, and fitted with a condenser. The reaction was cloudy at first, but cleared within two minutes. At about 1.75 hours, the flask was removed from the bath and 2.42 g of MEK was added to compensate for lost solvent. A 2.0 g sample was removed from the flask, leaving (1-(2.0/161.01) or 0.9876 weight fraction, of the reaction, and 57.51 g (98.76% of 58.23 g) (0.116 mol, 494.3 equivalent weight) PET3A was added to the reaction, which was placed in a 63 degrees Celsius bath. At about 5.25 hours FTIR showed no isocyanate absorption at 2273 cm⁻¹, and 0.56 g MEK was added to compensate for solvent lost to bring the material to 50% solids.

HFPO AEA (HFPO—C(O)NHCH₂CH₂OC(O)CH═CH₂) was prepared as described in File number U.S. application Ser. No. 10/841,159, filed May 7, 2004 (Docket No. 57927US002); under Preparation of Monofunctional Perfluoropolyether Acrylate (FC-1).

TMPTA Trimethylolpropane Triacrylate

The coating compositions of the surface layer were coated onto the hardcoat layer of using a precision, metered die coater. For this step, a syringe pump was used to meter the solution into the die. The solutions were diluted with MEK to a concentration of 1% and coated onto the hardcoat layer to achieve a dry thickness of 60 μm. The material was dried in a conventional air flotation oven and then cured a 600 watt Fusion Systems bulb under nitrogen using the conditions show below:

| | |
|---|---|
| Coating width: | 4″ (10 cm) |
| Web Speed: | 20 feet per minute |
| Solution % Solids: | 1.0% |
| Pump: | 60 cc Syringe Pump |
| Flow rate: | 1.2 cc/min |
| Wet Coating Thickness: | 4.1 microns |
| Dry Coating Thickness: | 60 nm |
| Conventional Oven Temps: | Zone 1 - 65° C. |
| | Zone 2 - 65° C. |

Both zones at 10 ft (3 m) in length.

TABLE 5
Coating Formulations Comprising Perfluoropolyether urethane
(meth)acrylate fluorinated component(s) (wt-% solids)

| | Perfluoropolyether | | | Static water |
|---|---|---|---|---|
| TMPTA | urethane | HFPO | Darocure | Contact angle |
| (%) | (meth)acrylate (%) | AEA | 1173 | (range in degrees) |
| 95 | 3.75 | 1.25 | 4 | 100-101 |
| 90 | 7.5 | 2.5 | 4 | |
| 85 | 11.25 | 3.75 | 4 | 110-111 |
| 80 | 15 | 5 | 4 | |
| 90 | 10 | | 4 | 93-94 |
| 80 | 20 | | 4 | 103-104 |

The results show that the hardcoats comprising the perfluoropolyether urethane acrylate exhibits high contact angles. Although not measured, these hardocat compositions are believed to have sufficiently low haze to employ on internal components of optical devices.

A 3″ by 4″, 1 mm thick polycarbonate (commercially available from GE under the trade designation “Lexan”) sheet suitable for use as a cover sheet was flood coated with the non-fluorinated hardcoat (47% solids) composition previously described by placing a bead of the solution across sheet at a sufficient amount to cover the sheet and allowing the composition to dry (to a thickness estimated to be about 4 microns). The hardcoat composition was cured with a Fusion UV Model MC6RQN, H bulb at 15 fpm, 100% under nitrogen blanket. Next the non-fluorinated hardcoat was flood coated with an easy-clean hardcoat composition consisting of 83.7 wt-% TMPTA, 9.6 wt-% of the perflurorpolyether urethane (meth)acrylate, 2.9 wt-% of the HFPO-AEA, and 3.8 wt-% of Darocure 1173 diluted to 2.5% solids with IPA. Again a bead of the solution was placed across the entire non-fluorinated hardcoat surface of the sheet. The composition was allowed to dry and then cured to an estimated thickness of about 10 nm with a Fusion UV Model MC6RQN, H bulb at 15 fpm, 100% under nitrogen blanket, 2 passes through UV chamber.

A glass sheet was coated in the same manner using the same non-fluorinated hardcoat and easy-clean hardcoat as used to coat the polycarbonate.

The camera lens from a digital camera was removed from the camera and coated with the same non-fluorinated hardcoat composition as the polycarbonate and glass sheet. Excess hardcoat was removed with a brush, dried, and cured with Fusion UV Model MC6RQN, H bulb at 15 fpm, 100% under nitrogen blanket. The camera lens was then dip coated into the same easy-clean hardcoat as used to coat the polycarbonate, remove excess coating solution with a brush, drying the coating, and curing with Fusion UV Model MC6RQN, H bulb at 15 fpm, 100% under nitrogen blanket, 2 passes through UV chamber.

The following reports the energy (J/cmˆ2) and power (W/cmˆ2) the sample received for the A, B, C, and V portions regions of the UV spectrum were recorded with a UV Power Puck manufactured by EIT (Sterling, Va.), when the puck was placed on the Fusion UV system conveyer belt at 15 fpm.

UV Fusion Systems
H Bulb
Model MC6RQN

| J/cm2 | | | | W/cm2 | | | |
|---|---|---|---|---|---|---|---|
| A | B | C | V | A | B | C | V |
| 0.855667 | 0.763667 | 0.100667 | 0.688667 | 1.378 | 1.342 | 0.157333 | 0.987333 |

The polycarbonate sheet, glass sheet, and lens having the hardcoat surface layer(s) were tested and found to exhibit ink repellency.

What is claimed is:

1. An article comprising an internal component of an optical device wherein the internal component comprises a hardcoat surface layer comprising the reaction product of a polymerizable composition comprising
i) at least 0.2 wt-% of at least one fluorochemical component having at least one polymerizable moiety, and
ii) at least 50 wt-% of one or more optionally fluorinated crosslinking agents.

2. The article of claim 1 wherein the internal component is unexposed to the external environment after assembly into the optical device.

3. The article of claim 1 wherein the crosslinking agents are non-fluorinated.

4. The article of claim 1 wherein the crosslinker comprises a fluorinated moiety and the composition comprises up to 100 wt-% of the crosslinker.

5. The article of claim 1 further comprising a second hardcoat layer disposed between the cured polymerizable composition and the internal component and the hardcoat surface layer.

6. The article of claim 1 wherein the fluorochemical component is selected from the group consisting of a monofunctional fluorinated component, a multifunctional fluorinated component, and mixtures of at least one monofunctional fluorinated component and at least one multifunctional fluorinated component.

7. The article of claim 11 wherein the fluorochemical component is selected (per)fluoropolyether (meth)acrylates, (per)fluoroalkyl(meth)acrylate, (per)fluoroalkylene (meth)acrylates, and mixtures thereof.

8. The article of claim 7 wherein the fluorochemical component comprises at least one acrylate polymerizable moiety.

9. The article of claim 7 wherein the fluorochemical component comprises a perfluoropolyether urethane (multi)acrylate.

10. The article of claim 7 wherein the fluorochemical component comprises a —HFPO group.

11. The article of claim 1 wherein the internal component is an optical film selected from the group consisting of multilayer optical films, microstructured films, polarizing films, diffusive films, retarder films, compensator films, monolithic transparent films.

12. The article of claim 11 wherein the internal component is a filter comprising the multilayer film.

13. The article of claim 1 wherein the optical device is selected from the group consisting of display devices, sensing devices, imaging devices, and projection devices.

14. The article of claim 1 wherein the internal component is selected from the group consisting of image sensors, a photosensors, silicon wafers, internal lens, prisms, beam splitters, filters, mirrors, polarizers, diffusers, and compensators.

15. An article comprising an internal component of an optical device wherein the internal component comprises a hardcoat surface layer and the surface layer has a static contact angle with water of at least 70 degrees.

16. A method of protecting an internal components of an optical device comprising:
providing a hardcoat surface layer on an internal components of an optical device wherein the surface layer comprises the reaction product of a polymerizable composition comprising
i) at least 0.2 wt-% of at least one fluorochemical component having at least one polymerizable moiety, and
ii) at least 50 wt-% of one or more crosslinking agents having two or more polymerizable moieties.

17. The method of claim 16 wherein the method comprises coating the internal component with the polymerizable composition on at least one surface and curing the composition.

18. The method of claim 17 wherein the polymerizable moieties are (meth)acryl moieties and the polymerizable composition is cured by means of ultraviolet radiation.

19. The method of claim 16 wherein the polymerizable composition is coated and cured on a light transmissible substrate and the coated substrate is bonded to the internal component.

20. The method of claim 1 wherein the polymerizable composition is coated and at least partially cured on a release liner and the at least partially cured composition is bonded to the internal component.
